(19) United States
(12) Patent Application Publication
(10) Pub. No.: US 2019/0331614 A1
(43) Pub. Date: Oct. 31, 2019

(54) INSPECTION SYSTEM AND METHOD FOR DRIVING INSPECTION SYSTEM

(71) Applicant: Sumitomo Chemical Company, Limited, Tokyo (JP)

(72) Inventor: Koji KASHU, Niihama-shi (JP)

(21) Appl. No.: 16/393,203

(22) Filed: Apr. 24, 2019

(30) Foreign Application Priority Data
Apr. 25, 2018 (JP) 2018-084118

(51) Int. Cl. G01N 23/04; G01N 21/88

(52) U.S. Cl. CPC G01N 23/04; G01N 21/8806; B65G 15/30; G01N 2223/646; G01N 2223/1016

(57) ABSTRACT

An inspection system is provided to inspect an inspection target efficiently. The inspection system includes a second chamber separate from a first chamber in which a radiation source section is present. The second chamber is surrounded by a wall that blocks an electromagnetic wave that the radiation source section emits. A separator roll is stocked in the second chamber.

This Nonprovisional application claims priority under 35 U.S.C. § 119 on Patent Application No. 2018-084118 filed in Japan on Apr. 25, 2018, the entire contents of which are hereby incorporated by reference.

### TECHNICAL FIELD

The present invention relates to (i) an inspection system for inspecting an inspection target for a defect in the inspection target and (ii) a method for driving the inspection system.

### BACKGROUND ART

Patent Literature 1 discloses, as an inspection device for inspecting an inspection target for a defect in the inspection target, an inspection device configured to (i) emit inspection light to an inspection target and (ii) analyze an image based on the inspection light to determine whether the inspection target includes a defect.

### CITATION LIST

### Patent Literature

### Patent Literature 1

Japanese Patent Publication No. 5673621.

### SUMMARY OF INVENTION

### Technical Problem

The above inspection device, which uses light, preferably includes a radiation source section and a sensor section in a space enclosed by, for example, a wall and separated from outside space in order to reduce influence of the inspection light on the surroundings of the inspection device and influence of external light on the inspection device.

In a case where an inspection target to be inspected or an inspection target having been inspected is stocked in the chamber in which the radiation source section and the sensor section are present, inspection light having been reflected by, for example, a wall is indirectly emitted to the stocked inspection target, degrading the quality of the stocked inspection target.

In a case where the inspection target is stocked outside the chamber in which the radiation source section and the sensor section are present, the inspection needs to be suspended, that is, the emission of inspection light by the radiation source section needs to be stopped, each time an inspection target is put into or taken out of the chamber, decreasing the inspection efficiency.

An aspect of the present invention has an object of inspecting an inspection target efficiently.

### Solution to Problem

In order to attain the above object, an inspection system in accordance with an embodiment of the present invention includes: a radiation source section configured to emit an electromagnetic wave capable of passing through an inspection target; a sensor section configured to detect the electromagnetic wave, which the radiation source section has emitted and which has passed through the inspection target; a stocking mechanism configured to stock the inspection target; a first chamber surrounded by a first wall that blocks the electromagnetic wave; a second chamber surrounded by a second wall that blocks the electromagnetic wave; and a first blocking section configured to allow the first chamber and the second chamber to communicate with each other, the first blocking section being capable of being opened and closed, the radiation source section and the sensor section being present in the first chamber, the stocking mechanism being present in the second chamber,

In order to attain the above object, a method in accordance with an embodiment of the present invention for driving an inspection system is a method for driving an inspection system, the inspection system including: a radiation source section configured to emit an electromagnetic wave capable of passing through an inspection target; a sensor section configured to detect the electromagnetic wave, which the radiation source section has emitted and which has passed through the inspection target; a stocking mechanism configured to stock the inspection target; a first chamber surrounded by a first wall that blocks the electromagnetic wave; a second chamber surrounded by a second wall that blocks the electromagnetic wave; and a first blocking section configured to allow the first chamber and the second chamber to communicate with each other, the first blocking section being capable of being opened and closed, the radiation source section and the sensor section being present in the first chamber, the stocking mechanism being present in the second chamber, the method including: placing the inspection target at a position between the radiation source section emitting the electromagnetic wave and the sensor section; the sensor section detecting the electromagnetic wave, which has passed through the inspection target, and outputting an electric signal corresponding to the electromagnetic wave that the sensor section has detected; after the sensor section has outputted the electric signal, carrying the inspection target, placed at the position between the radiation source section emitting the electromagnetic wave and the sensor section, into the second chamber; and placing another inspection target stocked in the second chamber at the position between the radiation source section emitting the electromagnetic wave and the sensor section.

### Advantageous Effects of Invention

An aspect of the present invention advantageously makes it possible to inspect an inspection target efficiently.

### BRIEF DESCRIPTION OF DRAWINGS

FIG. 1 provides diagrams schematically illustrating the configuration of a slitting apparatus in accordance with Embodiment 1.

FIG. 2 provides diagrams each schematically illustrating the configuration of a separator roll in accordance with Embodiment 1.

FIG. 3 is a planar diagram schematically illustrating the configuration of an inspection system in accordance with Embodiment 1.

FIG. 4 is a perspective view of an inspection system in accordance with Embodiment 1 with its schematic configuration illustrated.

FIG. 5 is a side view of an inspection system in accordance with Embodiment 1 with its schematic configuration illustrated.

FIG. 6 is a diagram schematically illustrating the configuration of an inspection device in accordance with Embodiment 1.

FIG. 7 is a diagram schematically illustrating the configuration of a radiation source section in accordance with Embodiment 1.

FIG. 8 is a diagram illustrating a captured image of a separator roll held by a holding mechanism of an inspection device in accordance with Embodiment 1.

FIG. 9 is a diagram illustrating the separator roll of FIG. 8 as has been rotated in the 0 direction by a predetermined angle.

FIG. 10 is a diagram illustrating an inspection image of a separator roll in accordance with Embodiment 1.

FIG. 11 is a diagram schematically illustrating the configuration and an operating state of a robot arm of Embodiment 1.

FIG. 12 is a diagram schematically illustrating the configuration of an inspection device in accordance with Embodiment 2.

FIG. 13 is a diagram illustrating an inspection image of a separator roll in accordance with Embodiment 2.

FIG. 14 is a diagram schematically illustrating the configuration and an operating state of a robot arm of Embodiment 3.

FIG. 15 is a planar diagram schematically illustrating the configuration of an inspection system in accordance with Embodiment 4.

FIG. 16 is a perspective view of a belt conveyor and a robot arm of the inspection system in accordance with Embodiment 4.

FIG. 17 is a planar diagram schematically illustrating the configuration of an inspection system in accordance with Embodiment 5.

FIG. 18 is a planar diagram schematically illustrating the configuration of an inspection system in accordance with Embodiment 6.

FIG. 19 is a planar diagram illustrating the configuration of an inspection system in accordance with Embodiment 7.

FIG. 20 is a planar diagram illustrating the configuration of an inspection system in accordance with Variation 1 of Embodiment 7.

FIG. 21 is a planar diagram illustrating the configuration of an inspection system in accordance with Variation 2 of Embodiment 7.

FIG. 22 is a planar diagram illustrating the configuration of an inspection system in accordance with Variation 3 of Embodiment 7.

FIG. 23 is a planar diagram illustrating the configuration of an inspection system in accordance with Embodiment 8.

FIG. 24 is a planar diagram illustrating the configuration of an inspection system in accordance with Embodiment 9.

FIG. 25 is a planar diagram illustrating the configuration of an inspection system in accordance with Variation 1 of Embodiment 9.

FIG. 26 is a planar diagram illustrating the configuration of an inspection system in accordance with Variation 2 of Embodiment 9.

FIG. 27 is a planar diagram schematically illustrating the configuration of an inspection system in accordance with Embodiment 10.

FIG. 28 is a planar diagram schematically illustrating the configuration of an inspection system in accordance with Embodiment 11.

FIG. 29 is a cross-sectional view schematically illustrating the configuration of the inspection system in accordance with Embodiment 11.

FIG. 30 is a cross-sectional view schematically illustrating the configuration of an inspection system in accordance with a variation of Embodiment 11.

FIG. 31 is a planar diagram schematically illustrating the configuration of an inspection system in accordance with Embodiment 12.

FIG. 32 is a cross-sectional view schematically illustrating the configuration of the inspection system in accordance with Embodiment 12.

FIG. 33 is a planar diagram schematically illustrating the configuration of an inspection system in accordance with Variation 1 of Embodiment 12.

FIG. 34 is a cross-sectional view schematically illustrating the configuration of the inspection system in accordance with Variation 1 of Embodiment 12.

FIG. 35 is a planar diagram schematically illustrating the configuration of an inspection system in accordance with Variation 2 of Embodiment 12.

FIG. 36 is a cross-sectional view schematically illustrating the configuration of the inspection system in accordance with Variation 2 of Embodiment 12.

FIG. 37 is a planar diagram showing an example of the configuration of a first blocking section of Embodiment 12 which first blocking section is divided into two.

FIG. 38 is a planar diagram schematically illustrating the configuration of an inspection system in accordance with Embodiment 13.

FIG. 39 is a planar diagram illustrating the configuration of an inspection system in accordance with Variation 1 of Embodiment 13.

FIG. 40 is a planar diagram illustrating the configuration of an inspection system in accordance with Variation 2 of Embodiment 13.

### DESCRIPTION OF EMBODIMENTS

### Embodiment 1

The following description will discuss an embodiment of the present invention. The present embodiment described here is an example inspection system for inspecting a separator roll (inspection target) for a defect in the separator roll.

(Process of Producing Separator Roll)

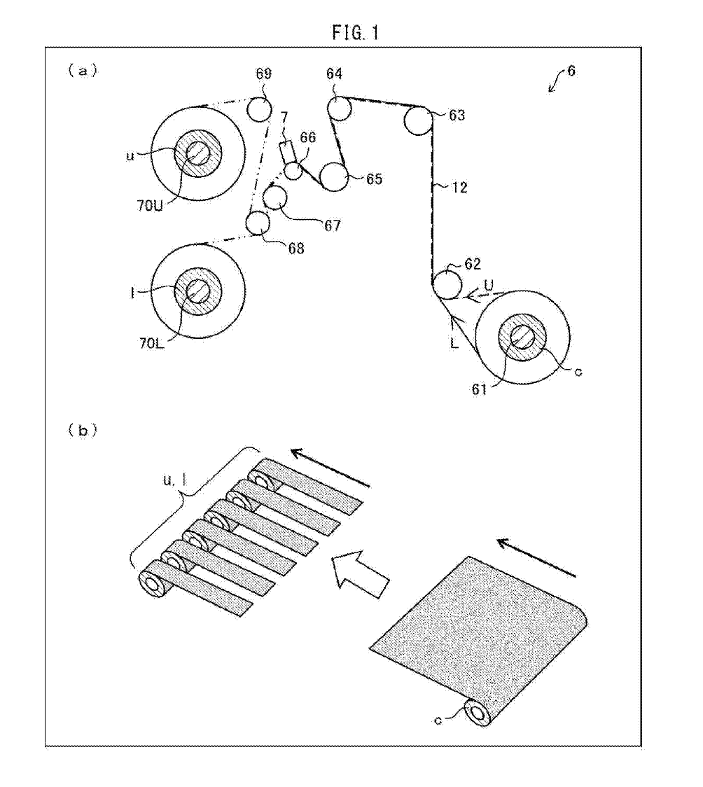

FIG. 1 provides diagrams schematically illustrating the configuration of a slitting apparatus 6 configured to slit a separator. (a) of FIG. 1 is a diagram schematically illustrating the overall configuration of the slitting apparatus 6. (b) of FIG. 1 is a diagram schematically illustrating an original sheet that has not been slit and an original sheet that has been slit.

While separating the positive electrode and the negative electrode (that is, the electrodes of a lithium-ion secondary battery or the like), the separator 12, which is a porous film, allows lithium ions to move between the positive electrode and the negative electrode. The separator 12 contains, for example, polyolefin such as polyethylene or polypropylene as a material.

The separator 12 may include a porous film and a heat-resistant layer on a surface of the porous film to have heat resistance. The heat-resistant layer may contain, for example, wholly aromatic polyamide (aramid resin) as a material thereof.

The separator 12 may be a layered porous film including (i) a porous film containing a polyolefin and (ii) a functional layer(s) such as an adhesive layer and a heat-resistant layer. The functional layer contains resin. Examples of the resin include: a polyolefin such as polyethylene or polypropylene; a fluorine-containing polymer such as polyvinylidene fluoride (PVDF), polytetrafluoroethylene, or a PVDF-hexafluoropropylene copolymer; an aromatic polyamide; a rubber such as a styrene-butadiene copolymer and a hydride thereof, a methacrylate ester copolymer, an acrylonitrile-acrylic ester copolymer, or a styrene-acrylic ester copolymer; a polymer having a melting point or glass transition temperature of not lower than 180° C.; and a water-soluble polymer such as polyvinyl alcohol, polyethylene glycol, cellulose ether, sodium alginate, polyacrylic acid, polyacrylamide, or polymethacrylic acid. The functional layer may contain a filler made of an inorganic substance or organic substance. The inorganic filler is made of, for example, an inorganic oxide such as silica, magnesium oxide, alumina, aluminum hydroxide, or boehmite. Alumina has crystal forms such as α-alumina, β-alumina, γ-alumina, and θ-alumina, and any of the crystal forms may be used. The resin and the filler may each contain (i) only one kind or (ii) two or more kinds in combination. In a case where the functional layer contains a filler, the filler may be contained in an amount of not less than 1% by volume and not more than 99% by volume of the functional layer.

The separator 12 should desirably contain as small an amount of water as possible for a minimized influence on the defect inspection described later. The defect inspection during the defect inspection step described later involves causing an electromagnetic wave such as X rays to pass through a separator 12 in order to inspect the separator 12, wound around a core, for a foreign object inside the separator 12. Since water decreases the transmittance of an electromagnetic wave such as X rays, the separator 12 containing a large amount of water will undesirably decrease the accuracy of the defect inspection.

The separator 12 may contain water in an amount of preferably up to approximately 2000 ppm. This makes it possible to (i) prevent a decrease in the transmittance of an electromagnetic wave such as X rays and (ii) accurately inspect a separator wound around a core for a defect inside the separator during the defect inspection step described later.

The separator 12 may preferably have a width (hereinafter referred to as “product width”) suitable for an application product such as a lithium-ion secondary battery. For an improved productivity, however, a separator is first produced to have a width that is equal to or larger than the product width. Then, after having been produced to have a width equal to or larger than the product width, the separator is slit to have the product width.

The expression “width of a/the separator” refers to that dimension of the separator which extends in a direction substantially perpendicular to the longitudinal direction of the separator and to the thickness direction of the separator. The description below uses the term “original sheet” to refer to a wide separator that has not been slit. Further, expressions such as “slitting” mean making a slit in a separator original sheet in the longitudinal direction (that is, the direction [carrying direction] in which the film is transferred during the production; machine direction [MD]), and expressions such as “cutting” mean cutting a separator original sheet in the transverse direction (TD). The transverse direction (TD) refers to a direction that is substantially perpendicular to the longitudinal direction (MD) of the separator and to the thickness direction of the separator.

The slitting apparatus 6 is configured to slit an original sheet. The slitting apparatus 6 includes a rotatably supported cylindrical wind-off roller 61, rollers 62 to 69, and wind-up rollers 70U and 70L.

In the slitting apparatus 6, a cylindrical core c around which an original sheet is wound is fit on the wind-off roller 61.

The original sheet is wound off from the core c to a route U or L. The original sheet having been wound off is conveyed to the roller 68 via the rollers 63 to 67. During the step of conveying the original sheet from the roller 67 to the roller 68, the original sheet is slit into a plurality of separators (slitting step). The slitting apparatus 6 includes a slitting device (not shown in FIG. 1) disposed near the roller 68 and configured to slit an original sheet into a plurality of separators.

After the slitting step, some of the separators produced by slitting the original sheet are each wound around a cylindrical core u (bobbin) fit on the wind-up roller 70U, whereas the other of the separators are each wound around a cylindrical core l (bobbin) fit on the wind-up roller 70L (separator winding step).

The present specification uses the term “separator roll” to refer to that which includes (i) a separator produced by slitting an original sheet and (ii) a core (bobbin) around which the separator is wound in the shape of a roll. The present embodiment is configured to, after a separator roll has been produced through the separator winding step, inspect the separator roll for any foreign object inside the separator (wound around the core) during the defect inspection step described later. During the slitting step described above, a foreign object tends to result from, for instance, a metal slitting blade being chipped and the resulting piece adhering to a surface of a slit separator. The defect inspection step may thus preferably be carried out after the slitting step. This makes it possible to efficiently inspect, during the defect inspection step, a separator for any foreign object resulting from the slitting step, during which a foreign object tends to result.

Separator rolls that have been determined as non-defective during the defect inspection step are later packed together in a package during a packaging step for storage.

The separator 12 produced by slitting an original sheet during the slitting step and wound around a core may preferably have a width (that is, the dimension in the TD) of, for example, approximately not less than 30 mm and not more than 100 mm. If the separator 12 has an excessively large width, an electromagnetic wave such as X rays will not easily pass through the separator 12 for the defect inspection during the defect inspection step described later, with the result of a decrease in the accuracy of the defect inspection. In view of that, the separator 12 having a width of approximately not more than 100 mm makes it possible to (i) prevent a decrease in the transmittance of an electromagnetic wave such as X rays and (ii) accurately inspect a separator wound around a core for a defect inside the separator during the defect inspection step described later.

(Configuration of Separator Roll)

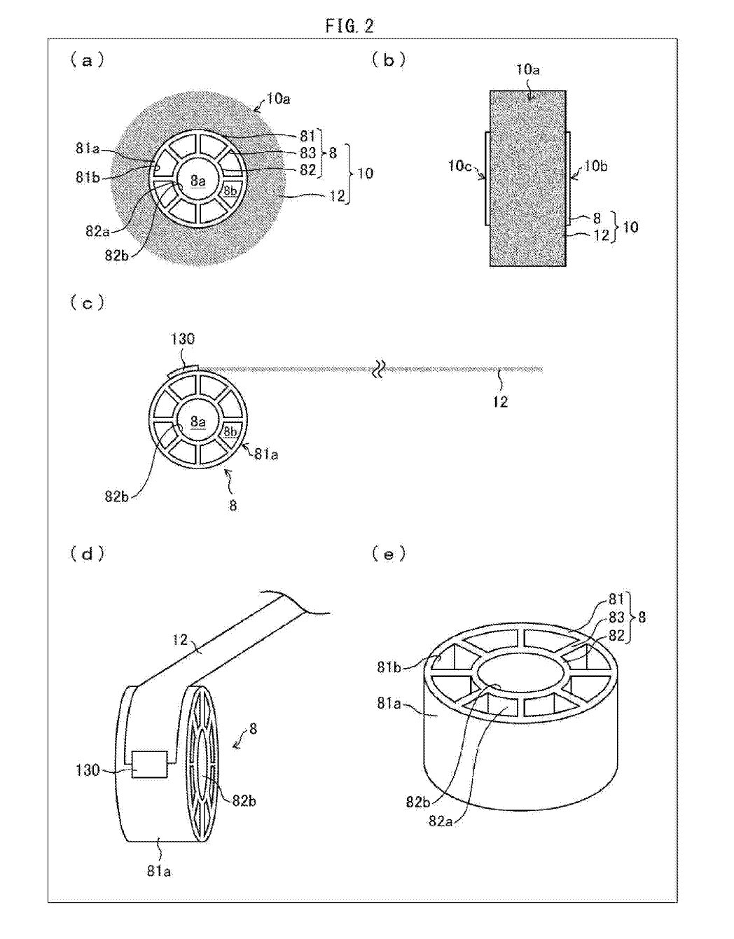

FIG. 2 schematically illustrates a configuration of a separator roll 10 in accordance with the present embodiment. Specifically, (a) of FIG. 2 illustrates a separator 12 which has not been wound off from a core 8. (b) of FIG. 2 illustrates the separator 12 of (a) of FIG. 2 from a different angle. (c) of FIG. 2 illustrates the core 8 from which the separator 12 has been wound off. (d) of FIG. 2 illustrates the separator 12 of (c) of FIG. 2 from a different angle. (e) of FIG. 2 illustrates the core 8 from which the separator 12 has been wound off and removed.

As illustrated in (a) and (b) of FIG. 2, the separator roll 10 includes the core 8 and the separator 12 wound around the core 8. The separator 12 has been produced by slitting the original sheet as described earlier. Among surfaces of the separator roll 10, an outer circumferential surface of the separator 12 wound in the roll shape is referred to as an outer peripheral surface 10a, and one and the other of side surfaces that face each other across the outer peripheral surface 10a are referred to as a first side surface 10b and a second side surface 10c, respectively.

The core 8 includes an outer cylindrical member (outer tubular member) 81, an inner cylindrical member (inner tubular member) 82, and a plurality of ribs 83. The core 8 is identical to the cores u and l mentioned earlier.

The outer cylindrical member 81 is a cylindrical member having an outer peripheral surface 81a around which to wind the separator 12. The inner cylindrical member 82 is a cylindrical member that is provided on a side of an inner peripheral surface 81b of the outer cylindrical member 81 and has a smaller diameter than the outer cylindrical member 81. The plurality of ribs 83 are support members that (i) extend from an outer peripheral surface 82a of the inner cylindrical member to the inner peripheral surface 81b of the outer cylindrical member 81 and (ii) support the outer cylindrical member 81 from the side of the inner peripheral surface 81b. According to the present embodiment, eight ribs 83 in total are provided at regular intervals in a circumferential direction of the core 8.

The core 8 has a first through hole 8a and a plurality of (in the present embodiment, eight) second through holes 8b. The first through hole 8a is provided at a center of the core 8 and is defined by the inner cylindrical member 82 (the inner peripheral surface 82b of the inner cylindrical member 82). The plurality of second through holes 8b is provided so as to surround the first through hole 8a and is defined by the outer cylindrical member 81, the inner cylindrical member 82, and the ribs 83.

As illustrated in (c) and (d) of FIG. 2, the separator 12 has an end attached to the core 8 with an adhesive tape 130. Specifically, the separator 12 has an end fixed to the outer peripheral surface 81a of the core 8 (outer cylindrical member 81) by use of the adhesive tape 130. An end of the separator 12 can be fixed to the outer peripheral surface 81a not only by using the adhesive tape 130 but also by, for example, applying an adhesive directly to the end of the separator 12 or using a clip.

As illustrated in (e) of FIG. 2, the core 8 is preferably configured such that central axes of the outer cylindrical member 81 and the inner cylindrical member 82 substantially coincide with each other. Note, however, that a configuration of the core 8 is not limited to the above configuration. Note also that the dimensions such as the thickness, the width, and the radius of each of the outer cylindrical member 81 and the inner cylindrical member 82 can be appropriately designed in accordance with, for example, a type of the separator 12 to be wound.

The ribs 83 are provided at regular intervals, at respective locations dividing the circumference of the core into eight equal parts, so as to substantially perpendicular to the outer cylindrical member 81 and the inner cylindrical member 82. Note, however, the number of ribs 83 and/or intervals at which to provide the ribs 83 is/are not limited to the above.

The core 8 contains ABS resin as a material thereof. The material of the core 8 is, however, not limited to ABS resin. The core 8 may contain, as a material thereof, a resin other than ABS resin such as polyethylene resin, polypropylene resin, polystyrene resin, or vinyl chloride resin. The core 8 should preferably not contain metal as a material thereof.

(Configuration of Inspection System 1)

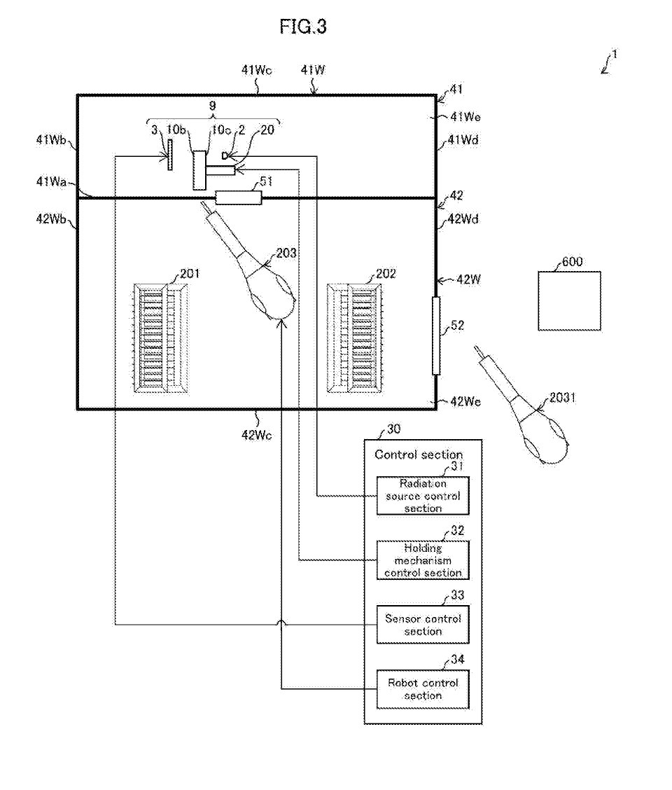

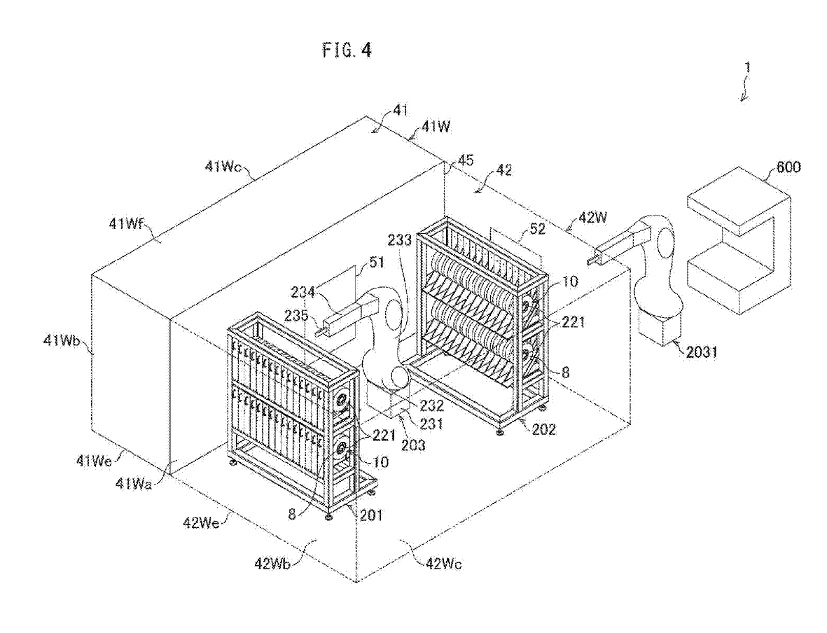

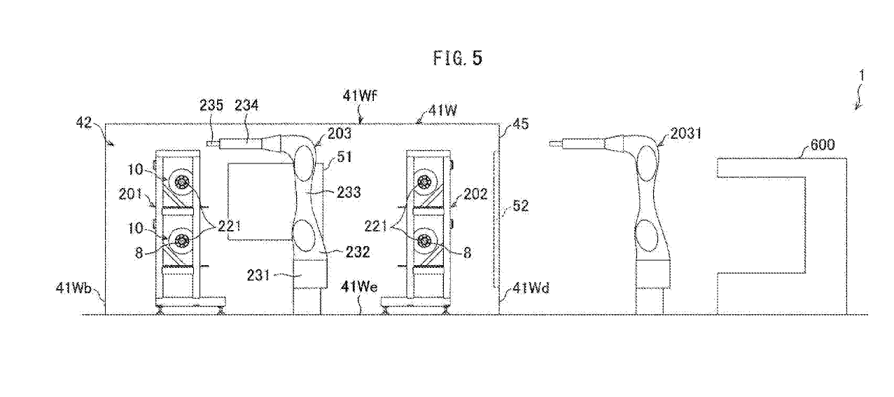

FIG. 3 is a planar diagram schematically illustrating the configuration of an inspection system 1 in accordance with Embodiment 1. FIG. 4 is a perspective view of the inspection system 1 in accordance with Embodiment 1 with its schematic configuration illustrated. FIG. 5 is a side view of the inspection system 1 in accordance with Embodiment 1 with its schematic configuration illustrated.

The inspection system 1 is configured to emit an electromagnetic wave to an inspection target to inspect the inspection target for a defect in the inspection target. The present embodiment described here is an example in which the inspection system 1 is configured to inspect a separator roll 10 for a defect therein, more specifically, to inspect a separator 12 wound around a core 8 for a foreign object in the separator 12, during a defect inspection step.

The inspection system 1, as illustrated in FIG. 3, includes (i) an inspection device 9 configured to inspect a separator roll 10 (inspection target) for a defect therein, (ii) racks (stocking mechanism) 201 and 202 for stocking a separator roll(s) 10, (iii) a robot arm (conveying mechanism) 203 for conveying a separator roll(s) 10, and (iv) a control section 30 for controlling how the individual sections of the inspection system 1 are driven. The inspection system 1 includes a first chamber 41, in which the inspection device 9 is present, and a second chamber 42, in which the racks 201 and 202 and the robot arm 203 are present. The inspection system 1 further includes (i) another robot arm (conveying mechanism) 2031 for conveying a separator roll(s) 10 and (ii) a packaging device 600 for packaging a separator roll 10.

The control section 30 includes (i) a radiation source control section 31 configured to control how a radiation source section 2 is driven, (ii) a holding mechanism control section 32 configured to control how a holding mechanism 20 is driven, (iii) a sensor control section 33 configured to control how a sensor section 3 is driven and form a captured image on the basis of an electric signal from the sensor section 3, and (iv) a robot control section 34 configured to control how the robot arm 203 is driven.

The inspection device 9 includes a radiation source section 2, a sensor section 3, and a holding mechanism 20.

The radiation source section 2 is configured to emit an electromagnetic wave that travels through a separator roll 10. The radiation source section 2 of the present embodiment is configured to emit an X ray as an electromagnetic wave. This configuration makes it possible to inspect a non-transparent object such as a separator roll 10 for a defect therein.

The electromagnetic wave that the radiation source section 2 is configured to emit is not limited to an X ray. The electromagnetic wave may be, for example, infrared light, visible light, or ultraviolet light, depending on the type of inspection target. The electromagnetic wave has a wavelength range that allows the electromagnetic wave to pass through the inspection target.

The sensor section 3 is configured to (i) detect an electromagnetic wave that has been emitted by the radiation source section 2 and that has passed through a separator roll 10 and (ii) output an electric signal corresponding to the intensity of the electromagnetic wave that the sensor section 3 has detected.

The holding mechanism 20 is configured to hold a separator roll 10 as an inspection target so that at least a portion (that is a portion to be inspected) of the separator roll 10 is positioned between the radiation source section 2 and the sensor section 3.

The radiation source section 2 emits the electromagnetic wave, which travels through a separator roll 10, to a separator roll 10 that the holding mechanism 20 is holding. The sensor section 3 detects the electromagnetic wave that has traveled through the separator roll 10. This configuration makes it possible to inspect a separator roll 10 for a defect therein.

The inspection device 9 may include the robot arm 203 in place of the holding mechanism 20. In a case where the inspection device 9 does not include the holding mechanism 20 as such, the robot arm 203 doubles as the holding mechanism 20. A later description will deal with how the inspection device 9 is configured in detail and specifically how the inspection device 9 carries out inspection.

The first chamber 41 is a space in which the inspection device 9 inspects a separator roll 10 for a defect. The second chamber 42 is a front chamber in which at least either a separator roll 10 to be inspected or a separator roll 10 having been inspected is placed temporarily.

As illustrated in FIGS. 3 to 5, the first chamber 41 is surrounded by a wall 41W that blocks an electromagnetic wave that the radiation source section 2 emits.

The wall 41W, by which the first chamber 41 is surrounded, includes sidewalls 41Wa to 41Wd, a floor 41We, and a ceiling 41Wf. The sidewalls 41Wa to 41Wd stand on the floor 41We. The sidewalls 41Wa and 41Wc face each other. The sidewalls 41Wb and 41Wd face each other. The ceiling 41Wf is supported by the sidewalls 41Wa to 41Wd and faces the floor 41We.

The second chamber 42 is surrounded by (i) a wall 42W that blocks an electromagnetic wave that the radiation source section 2 emits and (ii) the sidewall 41Wa. The wall 42W includes sidewalls 42Wb to 42Wd, a floor 42We, and a ceiling 42Wf. The sidewalls 42Wb to 42Wd stand on the floor 42We. The sidewalls 41Wa and 42Wc face each other. The sidewalls 42Wb and 42Wd face each other. The ceiling 42Wf is supported by the sidewall 41Wa and the sidewalls 42Wb to 42Wd and faces the floor 42We.

The present embodiment is configured such that the sidewall 41Wa is shared by the first chamber 41 and the second chamber 42 and separates the first chamber and the second chamber 42 from each other. The sidewall 41Wa is provided with a first blocking section 51 that serves to separate the first chamber 41 and the second chamber 42 from each other and that can be opened and closed. The sidewall 42Wd includes a second blocking section 52 that serves to separate the second chamber 42 and outside space from each other and that can be opened and closed. The first blocking section 51 and the second blocking section 52 also block an electromagnetic wave that the radiation source section 2 emits.

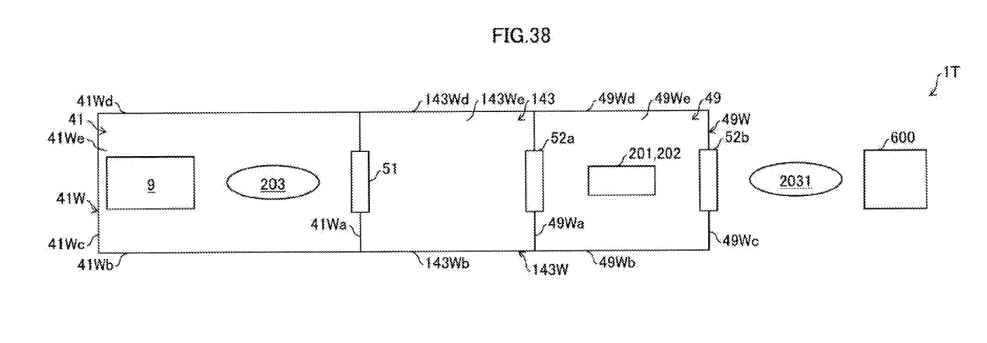

The present embodiment is configured such that the first chamber 41 and the second chamber 42 are adjacent to each other. The first chamber 41 and the second chamber 42, however, simply need to be each surrounded by a wall that blocks an electromagnetic wave that the radiation source section 2 emits. The first chamber 41 and the second chamber 42 may be apart from each other and connected with each other by, for example, a passage or a room (for example, a third chamber). Such a configuration will be described later with reference to FIGS. 38 to 40.

As illustrated in FIGS. 3 to 5, the racks 201 and 202 are each an example stocking mechanism configured to stock a plurality of separator rolls 10. The racks 201 and 202 are configured to accommodate and stock separator rolls 10. The stocking mechanism is not limited to the racks 201 and 202, and may be any member capable of stocking separator rolls 10.

The rack 201 stores a separator roll(s) 10 to be inspected, whereas the rack 202 stores a separator roll(s) 10 having been inspected.

The racks 201 and 202 each include one or more holding members 221 each configured to hold one or more separator rolls 10. Carrying the rack 201 into the second chamber 42 allows a separator roll(s) 10 to be inspected to be easily carried into the second chamber 42. Carrying the rack 202 out of the second chamber 42 allows a separator roll(s) 10 having been inspected to be easily carried out of the second chamber 42. A separator roll 10 may be carried from outside the second chamber 42 and placed onto the rack 201 with use of the robot arm 2031. A separator roll 10 may be taken out of the rack 202 and carried to outside the second chamber 42 with use of the robot arm 2031. Specifically, the robot arm 2031 helps carrying a separator roll(s) 10 into and out of the second chamber 42 through an opening thereof that is formed as the second blocking section 52 is opened. The robot arm 2031 may carry a separator roll(s) 10 out of the second chamber 42 and place the separator roll(s) 10 in the packaging device 600 present outside the second chamber 42. Packaging a separator roll(s) 10 immediately after inspection can prevent a new foreign object from adhering to the separator roll(s) 10. The robot arm 2031 may have a configuration identical to that of the robot arm 203.

The robot arm 2031 may be placed inside or outside the second chamber 42. The packaging device 600 is placed in a space outside the second chamber 42 and accessible through the opening thereof that is formed as the second blocking section 52 is opened.

The holding members 221 may each be any member capable of holding a separator roll(s) 10. The holding members 221 are, for example, each a bar-shaped member on which a separator roll(s) 10 is fitted in a state where the holding member 221 extends from the side of the second side surface 10c of the separator roll(s) 10 through the first through hole 8a of the core 8.

With the configuration, the racks 201 and 202 holds each separator roll 10, without coming into direct contact with the separator 12, while causing the outer peripheral surface 10a of the separator roll 10 to face the robot arm 203.

The inspection system 1 does not necessarily include a pre-inspection rack 201 and a post-inspection rack 202 separately. The inspection system 1 may include a single rack that doubles as (i) a member on which to place a separator roll(s) 10 that has not been inspected and (ii) a member on which to place a separator roll(s) 10 that has been inspected. For instance, the single rack has two stages disposed on top of each other, and one of the upper and lower stages is used to stock a separator roll(s) 10 that has not been inspected, whereas the other of the upper and lower stages is used to stock a separator roll(s) 10 that has been inspected.

The racks 201 and 202 can each include an anti-rotation member configured to prevent rotation of each of the plurality of separator rolls 10 held by the plurality of holding members 221. To the outer peripheral surface 10a of the separator roll 10, a label is ordinarily attached which indicates (i) product information on the separator 12 and/or (ii) a character or a numeral denoting various pieces of information on the separator roll 10 (e.g., a wound diameter (outer diameter) of the separator roll 10), or a code (a bar code, a QR code (Registered Trademark)) representing those pieces of information. The racks 201 and 202 each of which includes an anti-rotation member makes it possible to prevent a separator roll 10 held by a holding member 221 from rotating during, for example, movement of the racks 201 and 202. Thus, an orientation (location) of the label can be kept constant at all times. This makes it possible to easily read the label.

The racks 201 and 202 can each also be provided with, for example, wheels so that the racks 201 and 202 can be easily moved. The racks 201 and 202 may each be an automated cart. In a case where the racks 201 and 202 are each a cart provided with, for example, wheels, the racks 201 and 202 can be carried into and out of the second chamber 42 easily.

The racks 201 and 202 can each also be provided with a dustproof cover configured to prevent a foreign object from adhering to a separator roll 10 which is stocked on the racks 201 and 202. The configuration makes it possible to prevent a foreign object from adhering to the separator roll 10 stocked on the racks 201 and 202 during, for example, movement of the racks 201 and 202. Examples of such a dustproof cover include clean cloth that is used in a clean booth, an (antistatic) plastic sheet, and a metal plate.

Further, a separator roll 10 can be transferred between each of the racks 201 and 202 and the robot arm 203 by entry of a hand part of the robot arm 203 into a frame of the corresponding one of the racks 201 and 202. Alternatively, the separator roll 10 can be transferred between each of the racks 201 and 202 and the robot arm 203 outside the frame by a mechanism provided in a holding member 221 and configured to take out the separator roll 10 to an outside of the frame.

The robot arm 203 is a device configured to transfer a separator roll 10 between a holding mechanism 20 and each of the racks 201 and 202. The robot arm 203 includes a base 231, a pedestal 232, a first arm part 233, a second arm part 234, and a hand part 235.

The pedestal 232 is provided on the base 231 so as to be pivotable on an axis that extends in a vertical direction. The first arm part 233 is provided on an upper side (on a side of a first end opposite a second end at which the base 231 is located) of the pedestal 232. The first arm part 233 is axially supported by the pedestal 232 so as to be rockable forward and backward.

The second arm part 234 is provided on a tip side (on a side of a first end opposite a second end at which the pedestal 232 is located) of the first arm part 233. The second arm part 234 is axially supported by the first arm part 233 so as to be rockable upward and downward.

The hand part 235, which grips the separator roll 10, is provided on a tip side (on a side of a first end opposite a second end at which the first arm part 233 is located) of the second arm part 234. The hand part 235 is axially supported by the second arm part 234 so as to be rockable and rotatable.

The robot arm 203 can freely change its posture by pivoting or rotating each part of the robot arm 203 by controlling operation of an actuator configured to drive each joint of the robot arm 203.

The robot arm 203 holds the core 8 from the side of the first side surface 10b of the separator roll 10. Since the holding member 221 of each of the racks 201 and 202 and the robot arm 203 thus hold the core 8 from the sides of the respective different side surfaces of the separator roll 10, the separator roll 10 can be efficiently transferred between the holding mechanism 20, the rack 201, the rack 202, and the robot arm 203.

Note that it is possible to provide, for example, a joint part and a sliding part of the robot arm 203 with an antiscattering cover configured to prevent scattering of a dusted metal foreign object. Note also that an O-ring seal can be provided on a joint axis or a low-dust grease can be applied to the joint axis. Further, the robot arm 203 can additionally include a mechanism configured to suck a metal foreign object that has been dusted in the robot arm 203.

The present embodiment uses a vertical articulated robot arm as the robot arm 203. Alternatively, the present embodiment can also use a horizontal articulated robot arm, an orthogonal robot arm, a parallel link robot arm, or the like as the robot arm 203. A later description will, with reference to FIG. 11, deal with how a separator roll(s) 10 is transferred between the holding mechanism 20, the rack 201, the rack 202, and the robot arm 203.

(Main Advantages of the First Chamber 41 and the Second Chamber 42)

As illustrated in FIGS. 3 to 5, the inspection system 1 includes (i) a radiation source section 2, (ii) a sensor section 3, (iii) racks 201 and 202, (iv) a first chamber 41 surrounded by a wall 41W that blocks an electromagnetic wave that the radiation source section 2 emits, (v) a second chamber 42 surrounded by a wall 42W that blocks an electromagnetic wave that the radiation source section 2 emits and a sidewall 41Wa, and (vi) a first blocking section 51 separating the first chamber 41 and the second chamber 42 from each other. The radiation source section 2 and the sensor section 3 are present in the first chamber 41. The racks 201 and 202 are present in the second chamber 42.

The above configuration makes it possible to inspect a separator roll 10 for a defect therein, as the sensor section 3 detects an electromagnetic wave that the radiation source section 2 has emitted and that has passed through the separator roll 10.

With the above configuration, (i) the radiation source section 2 and the sensor section 3 are present in the first chamber 41, (ii) the racks 201 and 202 are present in the second chamber 42, (iii) the wall 41W, by which the first chamber 41 is surrounded, blocks an electromagnetic wave that the radiation source section 2 emits, and (iv) the wall 42W and the sidewall 41Wa, by which the second chamber 42 is surrounded, also block an electromagnetic wave that the radiation source section 2 emits.

This prevents an electromagnetic wave that the radiation source section 2 has emitted from leaking to outside the first chamber 41 and the second chamber 42.

Partitioning a chamber structure into a first chamber 41 and a second chamber 42 can reduce influence which an electromagnetic wave that the radiation source section 2 has emitted causes on the surroundings of the chamber structure.

Assuming that the electromagnetic wave that the radiation source section 2 emits is an X ray, even if the first blocking section 51 is opened while the radiation source section 2 is emitting an electromagnetic wave, the second chamber 42 separate from the first chamber can prevent the electromagnetic wave that the radiation source section 2 is emitting from leaking to a space outside the chamber structure. The above configuration in turn prevents an operator in the space outside the chamber structure from being exposed to an X ray that the radiation source section 2 is emitting.

In a case where the radiation source section 2 is configured to emit, for example, laser light, the second chamber 42 separate from the first chamber 41 can protect the eyes of an operator from the laser light. In a case where a light-sensitive production step is carried out in a space outside the chamber structure or a case where a light-sensitive material is stored in a space outside the chamber structure, the second chamber 42 separate from the first chamber 41 can (i) reduce the occurrence of problems such as deterioration of the production step or material caused by an electromagnetic wave that the radiation source section 2 emits or even (ii) prevent such problems from occurring.

Further, partitioning a chamber structure into a first chamber 41 and a second chamber 42 can reduce influence which light external to the chamber structure causes on the radiation source section and the sensor section.

In a case where (i) the electromagnetic wave that the radiation source section 2 emits is not an X ray but infrared light, visible light, ultraviolet light, or the like, and (ii) external light (illumination light) used in a space outside the first chamber 41 and the second chamber 42 contains light (infrared light, visible light, ultraviolet light, or the like) within a wavelength range identical to that of the electromagnetic wave that the radiation source section 2 emits, the above configuration can prevent light within the wavelength range from entering the sensor section. This can in turn prevent noise from being included in an image captured by the sensor section.

With the above configuration, the sidewall 41Wa separating the first chamber and the second chamber from each other is provided with a first blocking section 51.

Closing the first blocking section 51 can, in a case where an electromagnetic wave emitted by the radiation source section 2 has been reflected by, for example, the wall 41W (by which the first chamber 41 is surrounded), prevent such an electromagnetic wave from reaching a separator roll 10 stocked in the second chamber 42. As compared to a case where the second chamber 42 is absent, that is, a separator roll to be inspected and/or a separator roll having been inspected is stocked in a room in which a radiation source section and a sensor section are present, the above configuration can reduce or prevent quality degradation caused by the electromagnetic wave to a separator roll(s) 10 stocked in the chamber structure.

The walls 41W and 42W, by which the first chamber 41 and the second chamber 42 are respectively surrounded, each block an electromagnetic wave. Thus, opening the first blocking section 51 allows a separator roll 10 in the second chamber 42 to be carried out into the first chamber 41 and a separator roll 10 having been inspected in the first chamber 41 to be carried out into the second chamber 42 without stopping the emission of an electromagnetic wave by the radiation source section 2. This configuration makes it possible to continue inspection of a separator roll 10 efficiently.

The inspection system 1 includes a second chamber 42 separate from the first chamber 41 and surrounded by a wall 42W that blocks an electromagnetic wave that the radiation source section 2 emits. This makes it possible to replace a separator roll 10 while the radiation source section 2 is emitting an electromagnetic wave to the separator roll 10. Specifically, the inspection system 1 may be operated as follows:

The robot arm 203 carries a separator roll 10 out of the second chamber 42 into the first chamber 41, and causes the holding mechanism 20 to hold the separator roll 10. This places the separator roll 10 between the radiation source section 2 emitting an electromagnetic wave and the sensor section 3 (first step).

Next, the sensor section 3 detects an electromagnetic wave that has traveled through the separator roll 10 (held by the holding mechanism 20), and outputs an electric signal corresponding to the electromagnetic wave that the sensor section 3 has detected. This allows the sensor control section 33 to generate a captured image (second step).

The inspection system 1 ends capturing an image of an inspection region of the separator roll 10 (held by the holding mechanism 20). The sensor section has outputted an electric signal necessary for inspection of the separator roll 10. Then, the robot arm 203 removes the separator roll 10, which is placed between the radiation source section 2 emitting an electromagnetic wave and the sensor section 3, from the holding mechanism 20 and carries the separator roll 10 out of the first chamber 41 into the second chamber 42 (third step).

The robot arm 203 then carries another separator roll 10 on the rack 201 out of the second chamber 42 into the first chamber 41, and causes the holding mechanism 20 to hold the separator roll 10. This places the separator roll 10 between the radiation source section 2 emitting an electromagnetic wave and the sensor section 3 (fourth step). The process then returns to the second step.

The above process involves replacing a separator roll 10 without stopping and restarting the emission of an electromagnetic wave by the radiation source section 2. This saves the time period necessary to stop and restart the emission of an electromagnetic wave by the radiation source section 2, and also reduces or prevents degradation caused to the radiation source section 2 by frequently stopping and restarting the emission of an electromagnetic wave by the radiation source section 2.

In a case where the radiation source section 2 emits an X ray as the electromagnetic wave, the radiation source section 2 needs a certain length of time after the radiation source section 2 starts emitting an X ray and before the radiation source section 2 has a stable dose that ensures a signal-to-noise ratio (SN ratio) necessary for sufficient inspection performance. In a case where the inspection target is a separator roll, the radiation source section 2 needs a long time period for a stable dose. This is for reasons such as the following: (i) Since a separator roll has a thickness that is not so small, the radiation source section 2 needs a high X-ray energy. (ii) The radiation source section 2 needs to wait until in-plane variation of the SN ratio in a captured image becomes not more than a tolerance value. (iii) The defect as a detection target is so small in size that a high SN ratio is required.

If the inspection system does not include a second chamber surrounded by a wall that blocks an electromagnetic wave that the radiation source section emits, the emission of an X ray by the radiation source section will need to be stopped each time the first blocking section is opened to allow a separator roll to be carried into or out of the first chamber. Thus, each time the first blocking section is opened, the radiation source section will need a certain length of time to allow the X-ray dose to be stable enough to ensure an SN ratio necessary for inspection. This will result in a longer tact time for inspection of a separator roll.

The inspection system 1 includes a second chamber 42 separate from the first chamber 41 (in which the inspection device 9 is present) and surrounded by a wall 42W that blocks an electromagnetic wave that the radiation source section 2 emits. This makes it possible to replace a separator roll 10 for inspection while the radiation source section 2 is emitting an X ray as the electromagnetic wave.

The inspection system 1 is configured such that the second chamber 42 is surrounded by a wall 42W and a sidewall 41Wa (which separates the first chamber 41 and the second chamber 42 from each other), the wall 42W being provided with a second blocking section 52. FIGS. 3 to 5 illustrate an example in which the sidewall 42Wd (which is a wall different from the sidewall 41Wa) is provided with a second blocking section 52.

The first blocking section 51 and the second blocking section 52 each preferably include a material that blocks an electromagnetic wave that the radiation source section 2 emits. In a case where, for instance, the radiation source section 2 emits an X ray as the electromagnetic wave, the first blocking section 51 and the second blocking section 52 each preferably include lead. In a case where the radiation source section 2 emits infrared light, visible light, ultraviolet light, or the like as the electromagnetic wave, the first blocking section 51 and the second blocking section 52 each include a material that blocks infrared light, visible light, ultraviolet light, or the like.

With the above configuration, closing the first blocking section 51 allows, while the inspection device 9 continues to inspect a separator roll 10 for a defect therein in the first chamber 41, a separator roll 10 to be carried into the second chamber 42 through an opening formed as the second blocking section 52 is opened and a separator roll 10 having been inspected and stocked in the second chamber 42 to be carried out of the second chamber 42 through the opening formed as the second blocking section 52 is opened. This allows a separator roll 10 to be carried into and out of the second chamber 42 efficiently. This in turn allows the inspection device 9 to inspect a separator roll 10 efficiently.

The above configuration eliminates the need to stop and restart the emission of an electromagnetic wave by the radiation source section 2 each time a separator roll 10 is carried into the second chamber 42 or a separator roll 10 having been inspected and stocked in the second chamber 42 is carried out of the second chamber 42. This saves the time period necessary to stop and restart the emission of an electromagnetic wave by the radiation source section 2, and also reduces or prevents degradation caused to the radiation source section 2 by frequently stopping and restarting the emission of an electromagnetic wave by the radiation source section 2.

The inspection system 1 includes a robot arm 203 in the second chamber 42. The robot arm 203 is configured to hold a separator roll(s) 10 on the rack 201 and carry the separator roll(s) 10 out of the second chamber 42 into the first chamber 41 through an opening formed as the first blocking section 51 is opened. The robot arm 203 is also configured to hold a separator roll(s) 10 having been inspected in the first chamber 41 and carry the separator roll(s) 10 out of the first chamber 41 into the second chamber 42 through the opening formed as the first blocking section 51 is opened.

With the above configuration, closing the second blocking section 52 allows a separator roll 10 to be inspected to be carried by the robot arm 203 out of the second chamber 42 into the first chamber 41 and a separator roll 10 having been inspected to be carried by the robot arm 203 out of the first chamber 41 into the second chamber 42 without stopping the emission of an electromagnetic wave by the radiation source section 2. This makes it possible to inspect a separator roll 10 efficiently.

The first blocking section 51 is preferably present at such a position as to not be directly irradiated with an electromagnetic wave emitted by the radiation source section 2. For instance, the first blocking section 51 is next to the radiation source section 2 as illustrated in FIG. 3.

The above configuration can, even in a case where the first blocking section 51 and the second blocking section 52 have both been opened for a reason while the radiation source section 2 is emitting an electromagnetic wave, reduce the amount of electromagnetic wave that the radiation source section 2 is emitting and that leaks to outside the first chamber 41 and the second chamber 42.

Further, the above configuration can, even in a case where the first blocking section 51 has been opened while the radiation source section 2 is emitting an electromagnetic wave, reduce the amount of electromagnetic wave to which a separator roll 10 stocked in the second chamber 42 is exposed.

The second blocking section 52 is preferably non-parallel to the first blocking section 51. FIG. 4 illustrates an example in which the second blocking section 52 is non-parallel to the first blocking section 51, as the second blocking section 52 is provided at the sidewall 42Wd. The sidewall 42Wd is a portion of the wall 42W which portion is other than the sidewall 42Wc parallel to the sidewall 41Wa (which is provided with the first blocking section 51).

The above configuration can, in a case where the first blocking section 51 and the second blocking section 52 have both been opened for a reason during inspection in the first chamber 41, reduce the amount of electromagnetic wave that the radiation source section 2 is emitting and that leaks to outside the second chamber 42, as compared to a case where the first blocking section 51 and the second blocking section 52 are parallel to each other.

The second blocking section 52 may be provided at any of the sidewall 42Wb, the sidewall 42Wd, the floor 42We, and the ceiling 42Wf. The sidewall 42Wb and the sidewall 42Wd are each a portion of the wall 42W which portion is other than the sidewall 42Wc parallel to the sidewall 41Wa (which is provided with the first blocking section 51).

The first chamber 41 and the second chamber 42 are preferably in a clean room. This makes it possible to inspect a separator roll 10 in a clean environment, thereby making it possible to inspect a separator roll 10 for a defect more accurately.

The clean environment may preferably have a class of, for example, not more than 100,000. Carrying out inspection in such an environment makes it possible to reduce the risk of a new foreign object adhering to a separator roll 10 during or after the inspection.

The second chamber 42 may be provided with an air shower inside. This allows the first chamber 41 to have a cleaner environment, making it possible to inspect a separator roll 10 in the first chamber 41 more accurately. Further, with the above configuration, the inspection device 9 may be cleaned less frequently.

Even if the second chamber 42 is not provided with an air shower inside, the inspection system 1, which includes a second chamber 42, can (i) reduce the amount of dust or dirt entering the first chamber 41 and (ii) keep a highly clean environment, as compared to an inspection system that does not include a second chamber.

The second chamber 42 preferably has an environment (for example, cleanliness) identical to that of the first chamber 41, or preferably has a cleanliness (that is, how small the amount of suspended particles is) higher than that of the first chamber 41. The second chamber 42 preferably has a temperature and humidity that are regulated more strictly than for the first chamber 41.

In a case where the first chamber 41 and the second chamber 42 are in a clean room, the second chamber 42 preferably has (i) a cleanliness higher than that of a space outside the first chamber 41 and the second chamber 42 and has (ii) a temperature and humidity that are regulated more strictly than for the spatial outside the first chamber 41 and the second chamber 42.

The above configuration allows a separator roll(s) 10 to be stocked in the second chamber 42 in a clean state.

(Details of Inspection Device 9)

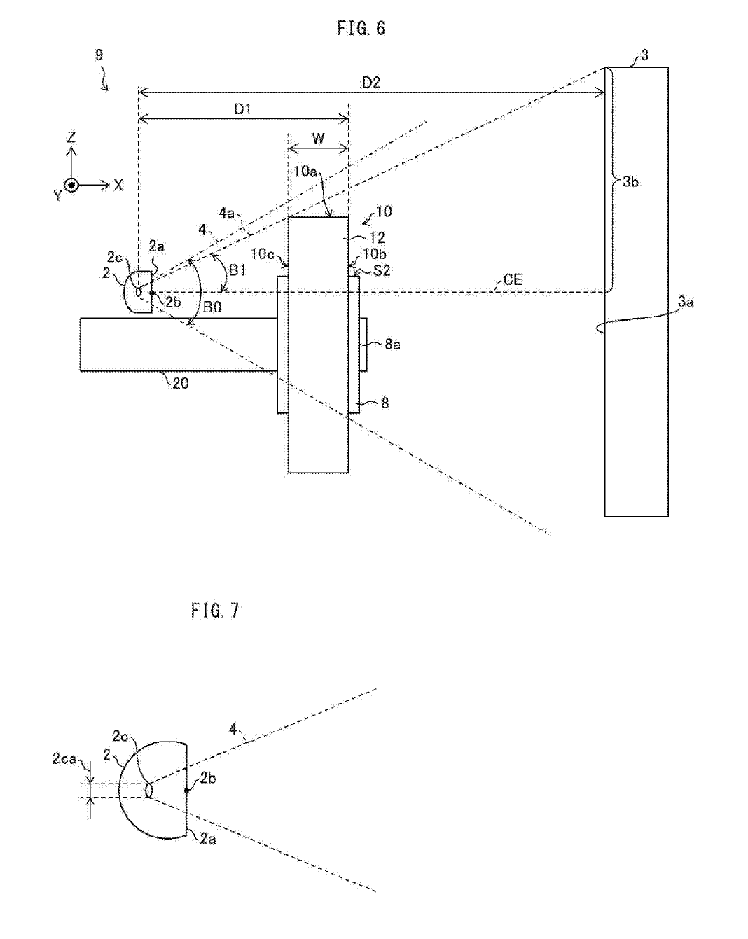

FIG. 6 is a diagram schematically illustrating the configuration of an inspection device 9 in accordance with Embodiment 1. The present embodiment is configured such that the radiation source section 2 emits an electromagnetic wave 4 in the X-axis direction (that is, the left-right direction of FIG. 3) and that the vertical direction (that is, the up-down direction of FIG. 3), which is perpendicular to the X axis, corresponds to the Z-axis direction.

The holding mechanism 20 is configured to hold a separator roll 10 as an inspection target in such a manner as to be capable of moving the separator roll 10 in the X-axis direction and the Z-axis direction. The holding mechanism 20, in other words, moves the separator roll 10 relative to the radiation source section 2. The holding mechanism 20 may be configured to be capable of moving the separator roll 10 also in the Y-axis direction (that is, the direction perpendicular to the surface of FIG. 3), which is perpendicular to the X-axis direction and the Z-axis direction.

The holding mechanism 20, which is shaped so as to extend in the X-axis direction, holds the separator roll 10 so that the separator roll 10 can rotate on an axis parallel to the X-axis. Specifically, the inspection device 9 holds the separator roll 10 by inserting the holding mechanism 20 in the first through hole 8a from the side of the second side surface 10c of the separator roll 10. The configuration allows the inspection device 9 to hold the separator roll 10 from the side of the first side surface 10b without coming into direct contact with the separator 12.

In the inspection device 9, the separator roll 10 is attached to the holding mechanism 20 in such a manner that at least a portion of the separator 12 wound around the core 8 is present between the radiation source section 2 and the sensor section 3.

The holding mechanism 20 may, for prevention of generation of a metal foreign object, preferably be configured such that at least its sliding section is made of resin. The resin is not limited to any kind. Examples of the resin include: a general-purpose resin such as polyethylene resin, polypropylene resin, polystyrene resin, vinyl chloride resin, acrylic resin, ABS, or polyester; an engineering plastic such as polyacetal, polyamide, polycarbonate, or modified polyphenylene ether; and a super engineering plastic such as polyalylate, polysulfone, polyether sulfone, polyphenylene sulfide, polyether ether ketone, polyimide, or polyetherimide. As the resin is for use in the sliding section, the resin may preferably be, among other resins, an abrasion-resistant super engineering plastic, more preferably polyether ether ketone. Embodiment 3 described later may preferably be configured such that the holding mechanism 20 is entirely made of resin.

With a separator roll 10 attached to the holding mechanism 20, the inspection device 9 is configured such that the radiation source section 2, the separator roll 10, and the sensor section 3 are arranged in this order in the X-axis direction. The separator roll 10 attached to the holding mechanism 20 has opposite side surfaces, one of which is a second side surface 10c facing the emitting surface 2a of the radiation source section 2 and the other of which is a first side surface 10b facing the detecting surface 3a of the sensor section 3.

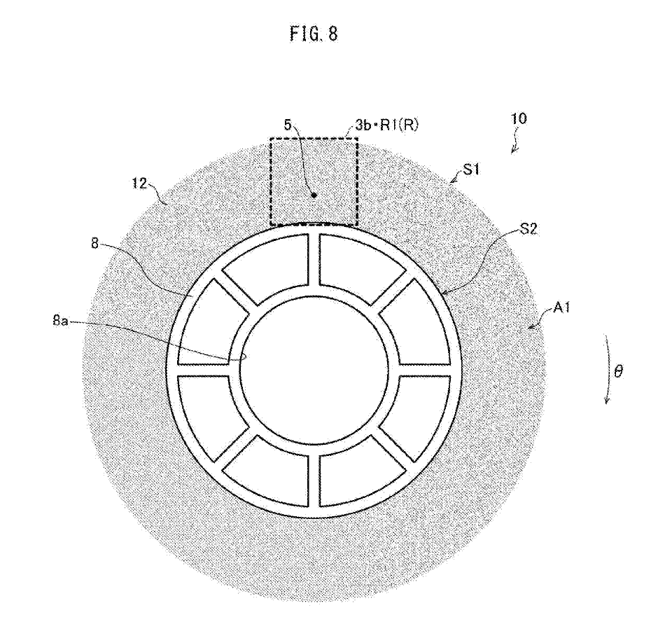

The inspection device 9 is configured to repeat the operation of (i) rotating the separator roll 10, which is held by the holding mechanism 20, in the 0 direction by a predetermined angle and (ii) capturing an image of the separator roll 10 in order to capture an image of the entire separator 12 wound around the core 8 in the shape of a ring. This image capturing will be described later in detail with reference to, for example, FIGS. 8 to 10.

As illustrated in FIG. 3, the sensor section 3 is a detector capable of detecting, at the detecting surface 3a, the electromagnetic wave emitted by the radiation source section 2. The sensor section 3, when it has detected the electromagnetic wave emitted by the radiation source section 2, outputs to the sensor control section 33 an electric signal corresponding to the intensity of the electromagnetic wave detected. The sensor control section 33, when it has received such electric signals from the sensor section 3, generates a captured image on the basis of those electric signals.

The sensor section 3 is a detector capable of detecting an electromagnetic wave having a wavelength range identical to the wavelength range of the electromagnetic wave that the radiation source section 2 emits. For instance, in a case where the radiation source section 2 is configured to emit X rays, the sensor section 3 is a detector capable of detecting X rays, and in a case where the radiation source section 2 is configuration to emit γ rays, the sensor section 3 is a detector capable of detecting γ rays.

The present embodiment is configured such that the sensor section 3 is capable of detecting X rays and is a flat-panel detector (FPD) including pixels arranged in a matrix. The sensor section 3 is a FPD including, for example, pixels arranged in a matrix of 1500×1500 or 2000×2000 which pixels each have a size (for example, 20 μm to 2000 μm) suitable for the size of a foreign object as a detection target.

The sensor section 3 may have a detecting surface 3a having an area smaller than the area of the first side surface 10b or second side surface 10c of the separator roll 10. This is because the present embodiment is configured to create a captured image of the entire separator roll 10 by (i) repeating the operation of rotating the separator roll 10 and capturing an image of a portion of the separator 12 wound around the core 8 in multiple layers in the shape of a ring, (ii) extracting necessary regions from those captured images, and (iii) connecting the necessary regions.

The radiation source section 2 emits an electromagnetic wave 4 toward a side surface of a separator roll 10. The radiation source section 2 of the present embodiment is configured to emit an electromagnetic wave 4 that passes, in the transverse direction (TD), through the separator 12 of a separator roll 10 which separator 12 has a width W. Examples of such an electromagnetic wave 4 include an electromagnetic wave having a wavelength within a range of 1 μm to 10 nm.

The electromagnetic wave 4, which the radiation source section 2 emits, may preferably be X rays among others. This makes it possible to produce an inspection device 9 that is inexpensive and easy to use, as compared to a case in which the radiation source section 2 emits γ rays.

The electromagnetic wave 4, which the radiation source section 2 emits, may preferably have an intensity of not less than 1 W. This ensures that the electromagnetic wave 4 passes through a separator 12 in the transverse direction (TD). If the electromagnetic wave 4 has a low intensity, the exposure time period for the sensor section 3 will need to be long. In view of that, the electromagnetic wave 4, which the radiation source section 2 emits, may preferably have an intensity of not less than 10 W. This allows the exposure time period for the sensor section 3 to be short.

If the electromagnetic wave 4 has too high an intensity, the radiation source section 2 may have a short life. In view of that, the electromagnetic wave 4, which the radiation source section 2 emits, may preferably have an intensity of not more than 100 W. This prevents the radiation source section 2 from having a short life.

The emitting surface 2a of the radiation source section 2, from which emitting surface 2a the radiation source section 2 emits the electromagnetic wave 4, faces the detecting surface 3a of the sensor section 3 with a separator roll 10 therebetween that has been set in the inspection device 9.

In a case where the electromagnetic wave 4 of the present embodiment has a wavelength within a range of 1 μm to 10 nm, the present specification may use the term “focus 2c” to refer to the point source of the radiation source section 2 which point source is for emitting the electromagnetic wave 4 radially. The focus 2c has a center 2d that coincides with the center 2b of the emitting surface 2a as viewed in the X-axis direction.

FIG. 7 is a diagram schematically illustrating the configuration of a radiation source section 2 in accordance with Embodiment 1. The radiation source section 2 may ideally have a point light source. The focus 2c typically has a diameter 2ca within a range of approximately 1 μm to 20 μm.

The present embodiment assumes, as illustrated in FIG. 6, that (i) the focus 2c and the first side surface 10b of the separator roll 10 are separated from each other by a distance D1 and that (ii) the focus 2c and the detecting surface 3a of the sensor section 3 are separated from each other by a distance D2.

As illustrated in FIG. 6, in a case where the inspection device 9 carries out a measurement at a high magnification, there will be a large influence of displacement due to the size of the focus 2c. The case of carrying out a measurement at a high magnification means a case of carrying out a measurement in which D2(D2/D1) is large relative to D1, whereas the case of carrying out a measurement at a low magnification means a case of carrying out a measurement in which D2 (D2/D1) is small relative to D1.

As described above, the radiation source section 2 emits an electromagnetic wave 4 to a side surface of a separator roll 10, the electromagnetic wave 4 traveling through the separator roll 10 to be detected by the sensor section 3. This configuration makes it possible to inspect a separator roll 10 for a defect inside the separator roll 10 such as a foreign object inside the separator roll 10.

As described above, the inspection device 9 is capable of, after a separator roll 10 has been produced, inspecting the separator 12 around a core for any defect inside the separator 12. This eliminates the need to prepare a defect inspection device for each of a plurality of sheet-shaped separators produced by slitting an original sheet during the slitting step. This means that there is no need to prepare two or more inspection devices.

The radiation source section 2 emits an electromagnetic wave 4 to a separator roll 10 held by the holding mechanism 20, and the sensor section 3 detects that electromagnetic wave 4. This configuration eliminates the need to capture an image of a separator being conveyed, thereby making it possible to capture an image of a separator roll 10 at rest. This in turn ensures a sufficient exposure time period for the sensor section 3, thereby making it possible to capture a clear image for accurate defect inspection.

While the exposure time period for the sensor section 3 may preferably be long for an improved SN ratio, the exposure may be a continuous exposure operation or include a plurality of repeated short-time exposure operations. In a case where the inspection device 9 has captured images through a plurality of repeated short-time exposure operations, the inspection device 9 then superimposes each image over the others. Carrying out such a plurality of exposure operations is preferable because it reduces noise over continuous exposure.

The inspection device 9 does not need to capture an image of the full length of a separator 12 being conveyed, and is capable of inspecting a separator roll 10 as a wound product. This makes it possible to carry out defect inspection within a short time.

In a case where the defect inspection involves use of a high-energy electromagnetic wave such as X rays or γ rays, a radiation source and a sensor need to be surrounded by a wall containing, for example, lead for prevention of influence on the human body. If such a configuration is to be used to carry out defect inspection through emission of X rays to a separator or separator roll being conveyed, the surrounding wall will need to be large, with the unfortunate result of a large device.

In contrast, the inspection device 9, which is configured to capture an image of a separator roll 10 held by the holding mechanism 20, can include a relatively small wall around the radiation source section 2 and the sensor section 3 in a case where the inspection device 9 uses X rays or γ rays as the electromagnetic wave 4. As a result, the inspection device 9 can be relatively small as a whole.

The radiation source section 2 emits an electromagnetic wave 4 to a separator roll 10 from the side of a side surface of the separator roll 10. This configuration makes it possible to create a captured image based on an electromagnetic wave 4 that has passed through, of the entire separator roll 10, only the separator 12 wound around a core 8. This in turn makes it possible to create a particularly clear captured image of the inside of a separator 12 wound around a core 8.

A separator roll 10 has not so small a thickness of, for example, several centimeters. The electromagnetic wave needs to have a high energy to pass through a separator roll 10. Including a second chamber 42 separate from the first chamber 41 surrounded by a wall 42W that blocks an electromagnetic wave that the radiation source section 2 emits can ensure safety of an operator more reliably.

The radiation source section 2 is configured to emit an electromagnetic wave 4 to a separator roll 10 in such a manner that the electromagnetic wave 4 strikes not only the separator 12 wound around a core 8 but also the core 8. The image captured by the sensor section 3 detecting an electromagnetic wave 4a may preferably include not only an image of the separator 12 but also an image of the core 8. The inspection device 9 is capable of creating a captured image of a wide area of a separator roll 10 as described above. This configuration makes it possible to reduce the number of image-capturing operations necessary and inspect the entire separator roll 10 thoroughly for a defect.

In a case where the inspection device 9 uses X rays or γ rays as the electromagnetic wave 4, the radiation source section 2 emits the electromagnetic wave 4 from the focus 2c radially with an angle B0. Thus, that electromagnetic wave 4 which has been emitted from the center 2b of the emitting surface 2a of the radiation source section 2 (that is, that electromagnetic wave 4 which has been emitted from the focus 2c in a direction perpendicular to the emitting surface 2a) travels through a separator roll 10 in a direction parallel to the film surface of the separator 12 wound around a core 8 and strikes the detecting surface 3a of the sensor section 3 in a direction perpendicular to the detecting surface 3a. That electromagnetic wave 4 which has been emitted from a position apart from the center 2b of the emitting surface 2a of the radiation source section 2 (that is, that electromagnetic wave 4 which has been emitted from the focus 2c in a direction inclined from the electromagnetic wave 4 that has been emitted in a direction perpendicular to the emitting surface 2a) travels through a separator roll 10 in an accordingly oblique direction relative to the film surface of the separator 12 wound around a core 8 and strikes the detecting surface 3a of the sensor section 3 in an accordingly oblique direction relative to the detecting surface 3a.

An emission line may show in that region of a captured image of a separator 12 which has been obtained on the basis of an electromagnetic wave 4 that has traveled through the separator roll 10 in a direction parallel to the film surface of the separator 12, as compared to that region of the captured image which has been obtained on the basis of an electromagnetic wave 4 that has traveled through the separator roll 10 in an oblique direction relative to the film surface of the separator 12. The emission line renders less visible an image of a defect caused by, for example, a foreign object inside a wound separator 12, and may result in a false negative in defect detection. In a case where a captured image shows an emission line, a false negative in defect detection may be prevented by (i) changing the positional relationship between the radiation source section 2 and the separator 12 and (ii) capturing an image again of that portion in which the emission line is observed.

Specifically, after an image has been captured of an outer peripheral region of a separator 12, an image is captured again of that inner peripheral region of the separator 12 which coincides with that outer peripheral region in which an emission line shows. This makes it possible to inspect a separator for a defect without a false negative in defect detection even in a case where an emission line shows in an outer peripheral region of the separator. Further, capturing a plurality of images of overlapping regions while changing the positional relationship between the radiation source section 2 and a separator 12 as described above makes it possible to prevent a false negative in detecting a flat, thin foreign object among foreign objects each having a circumscribed sphere with a diameter of not less than 100 μm.

In terms of prevention of an emission line, the radiation source section 2 may preferably have an emitting surface 2a whose center 2b is so positioned as not to face that portion of the corresponding side surface of a separator roll 10 held by the holding mechanism 20 which is not the wound separator 12, and may more preferably have an emitting surface 2a whose center 2b is so positioned as to face the corresponding side surface of the core 8, which is closer to the center of the separator roll 10 than the ring portion (that is, the wound separator 12) is to the center of the separator roll 10.

The above configuration causes an electromagnetic wave 4 having been emitted from the center 2b of the emitting surface 2a to (i) travel through not the separator 12 but the core 8 of a separator roll 10 and (ii) strike the detecting surface 3a of the sensor section 3. This prevents an emission line from showing in a captured image of a separator 12.

X rays are emitted radially from the focus 2c as the center. An electromagnetic wave 4 travels through the wound separator 12 in an oblique direction relative to the film surface of the separator 12 and strikes the detecting surface 3a of the sensor section 3. This prevents an emission line from showing in that portion of the captured image which corresponds to the image of the wound separator 12, and in turn prevents a false negative in defect detection without increasing the number of image-capturing operations.

The inspection device 9 is configured such that no structure is present, and only air is present, between the radiation source section 2 and a separator roll 10 held by the holding mechanism 20 and between a separator roll 10 held by the holding mechanism 20 and the detecting surface 3a of the sensor section 3.

The inspection device 9, which is configured as above, is capable of creating a clear captured image of a separator roll 10 as compared to a case in which a structure is present between a separator roll and a light-receiving surface of a sensor section. The inspection device 9 is thus capable of accurately inspecting a separator roll 10 for a defect inside the separator roll 10.

Assuming as described above that the focus 2c and the first side surface 10b of the separator roll 10 are separated from each other by a distance D1 and that the focus 2c and the detecting surface 3a of the sensor section 3 are separated from each other by a distance D2, the present specification defines D2/D1 as a measurement magnification.

The inspection device 9 is capable of creating a high-resolution X-ray image of an inspection target over its entire region within a short time. The time length necessary to inspect a separator roll 10 is given by the formula below. D2 needs to be set in such a manner as to minimize the time length.

(Exposure time period+Convey time)×Number of

image-capturing operations (Formula 1)

With D2/D1 fixed, multiplying D1 (that is, the distance between the focus 2c and the separator roll 10) by X results in 1/(X²) as the dose per (time period·area) of the detecting surface 3a. This indicates that in a case where D1 is multiplied by X, receiving the same dose at the detecting surface 3a requires the exposure time period to be proportional to X². Thus, in terms of the exposure time period, D1 is advantageously as small as possible. Decreasing D1, on the other hand, narrows the range over which the inspection device 9 is capable of capturing an image of a separator roll 10. This indicates that while decreasing D1 shortens the exposure time period, it increases (i) the number of image-capturing operations which number is necessary to cover the entire region and (ii) the number of movements between image-capturing operations, with the result of an increase of the time for defect inspection.

Decreasing D2 increases the resolution of a captured image of a separator roll 10 accordingly, but decreases the measurement magnification. This requires the sensor section 3 to have a high resolving power, that is, a sensor section (FPD) having a small pixel size. Increasing D2, on the other hand, reduces the constraint on the pixel size of the sensor section 3, but results in a larger sensor section or a larger inspection device, with the result of an increase in the space cost. Since an electromagnetic wave having a wavelength within a range of 1 μm to 10 nm is emitted radially by a radiation source, the size of a foreign object (detection target) as projected on the sensor section 3 is larger than the actual size of the foreign object. The pixel size of the sensor section 3 may be selected in view of how many pixels are to be used to detect a foreign object (detection target). In a case where, for instance, three or more pixels are to be used to detect a foreign object having a size of 100 μm, the pixel size may be selected with the lower limit being 100 μm÷3 (≈33 μm).

In view of the above matters, D1 may preferably be not less than 1.5 times and not more than 4 times the width W, D2 may preferably be not less than 0.3 m and not more than 10 m, and D2/D1 may preferably be more than 1 and not more than 40. The sensor section 3 (FPD) may preferably have a pixel size of not less than 20 μm and not more than 2000 μm. This configuration makes it possible to (i) shorten the time length necessary for defect inspection of a separator roll 10 and (ii) carry out the defect inspection accurately.

A single image-capturing operation may take a time period that is adjusted as appropriate on the basis of, for example, the time length necessary to inspect a single separator roll 10, the sensitivity of the sensor section 3, and/or the number of products to be processed (that is, the number of separator rolls 10 to be inspected) as long as the inspection device 9 is capable of capturing an image of a defect having a size targeted for detection.

Depending on, for example, the time length necessary to inspect a single separator roll 10, the sensitivity of the sensor section 3, and/or the number of products to be processed (that is, the number of separator rolls 10 to be inspected), the inspection device 9 may inspect a plurality of separator rolls 10 simultaneously by, for instance, (i) simultaneously capturing an image of a plurality of separator rolls 10 that are placed on top of one another in the X direction or (ii) simultaneously capturing an image of a plurality of separator rolls 10 arranged next to one another on the ZY plane.

(How the Inspection Device 9 Carries Out Inspection)

FIG. 8 is a diagram illustrating a captured image of a separator roll 10 held by the holding mechanism 20. Although FIG. 8 illustrates a captured image of the entire separator roll 10, the inspection device 9 may capture an image of (i) only a target region 3b described later of the separator roll 10 or (ii) only a portion of the separator roll 10 which portion includes a target region 3b.

The sensor control section 33 sets a target region 3b in a captured image of a separator roll 10 to actually determine whether the separator roll 10 has any defect.

Depending on, for example, (i) the angle at which the electromagnetic wave 4 enters a separator roll 10 and/or (ii) the length of the path through which the electromagnetic wave 4 has traveled from the emitting surface 2a of the radiation source section 2 to the detecting surface 3a of the sensor section 3, the captured image includes a region in which a clear image is shown and a region in which an unclear image is shown. Using a region of a captured image in which region a clear image is shown makes it possible to reduce the number of false negatives in defect detection for accurate defect inspection.

In view of the above, the sensor control section 33 sets, as a target region 3b, a region of a captured image in which region a clear image is shown.

In a case where the inspection device 9 has captured an image of a range and position identical to those of a target region 3b, the inspection device 9 may use the captured image as a target region 3b.

The present embodiment is configured such that the sensor control section 33 sets, as a target region 3b, a quadrangular region including a portion of the outer peripheral surface S2 of the core 8 and a portion of the outer peripheral surface S1 of the separator 12. In other words, the target region 3b includes (i) a portion of the core 8 and (ii) a portion of the wound separator 12 over the full depth (the depth being the up-down direction of FIG. 11).

FIG. 6 shows a center line CE, which extends from the center 2b of the emitting surface 2a of the radiation source section 2 to the detecting surface 3a of the sensor section 3 in a direction perpendicular to the detecting surface 3a.

The target region 3b has a dimension in the up-down direction which dimension extends along the area of the sensor section 3 which area an electromagnetic wave 4a among other electromagnetic waves 4 strikes through a separator roll 10, the electromagnetic wave 4a being emitted radially with an angle B1 relative to the center line CE which angle B1 covers the outer periphery of the second side surface 10c of the separator roll 10.

The center line CE extends through the core 8 of the separator roll 10, the core 8 being closer to the center of the separator roll 10 than the separator 12 is to the center of the separator roll 10.

When the sensor control section 33 has set a target region 3b as illustrated in FIG. 8, the inspection device 9 captures an image of the separator roll 10 attached to the holding mechanism 20.

The capturing of an image means the following operation: The radiation source section 2 emits an electromagnetic wave 4 in response to an instruction from the radiation source control section 31. The sensor section 3 detects the electromagnetic wave 4 emitted by the radiation source section 2 and having passed through the separator roll 10, and outputs to the sensor control section 33 an electric signal corresponding to the intensity of the electromagnetic wave 4 detected. The sensor control section 33 receives such electric signals from the sensor section 3, and generates a captured image based on those electric signals.

Next, the sensor control section 33 extracts, from the captured image generated, a first region R1, which corresponds to the target region 3b.

FIG. 8 shows in the first region R1 a foreign object 5 as a defect to be detected. The foreign object 5 may be made of any of various materials such as metal and carbon. The foreign object 5 to be detected may have any of various sizes. The foreign object 5 may be, as an example, 100 μm and have a thickness of approximately 50 μm. When the present specification specifies the size of a foreign object simply as, for example, “100 μm” without specifying it as the thickness or width, that dimension means the diameter of the circumscribed sphere of the foreign object.

The foreign object 5 as a defect to be detected tends to, in a case where it has a large specific gravity, be detectable even if it is small. Assuming that the defect to be detected is a metal foreign object, in a case where a metal having a specific gravity of approximately is detectable with a size down to, for example, approximately 100 μm under a certain inspection condition, a metal having a specific gravity of approximately 2 is detectable with a size down to approximately 300 μm. The inspection device 9 may be configured such that the size of a foreign object 5 as a detection target is set as appropriate according to the kind (that is, specific gravity) of a metal foreign object as a detection target.

The inspection device 9 is capable of detecting a small foreign object 5 in a case where the inspection device 9 has extended the time for inspection by, for example, extending the exposure time period and/or carrying out a plurality of image-capturing operations for the same region of a separator roll 10. Thus, the relationship described above between the specific gravity of a metal foreign object as a detection target and its size assumes a fixed inspection time length.

As the respective specific gravities of typical metals, Fe has approximately 7.8, Al has approximately 2.7, Zn has approximately 7.1, stainless steel has approximately 7.7, Cu has approximately 8.5, and brass has approximately 8.5. The metal material of a foreign object 5 is, however, not limited to these examples.

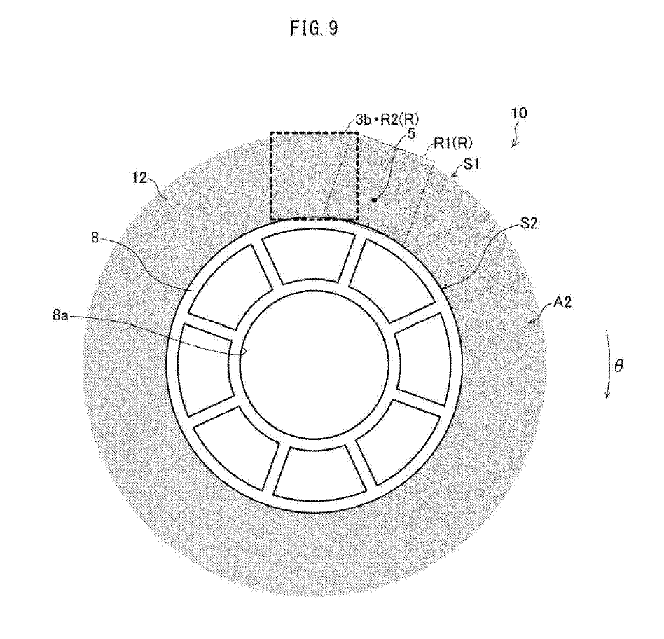

FIG. 9 is a diagram illustrating the separator roll 10 of FIG. 8 as has been rotated in the 0 direction by a predetermined angle.

After the sensor control section 33 has extracted, from a captured image, a first region R1 (which corresponds to a target region 3b), the holding mechanism control section 32 rotates the holding mechanism 20 in the 0 direction by a predetermined angle as illustrated in FIG. 9. This causes the holding mechanism 20 and the separator roll 10 to (i) rotate in the 0 direction by the predetermined angle and then (ii) stop. The present specification uses the term “region R” to refer to a region that for each rotation of the separator roll 10 in the θ direction, the sensor control section 33 extracts from a captured image and that corresponds to the target region 3b.

The predetermined angle, by which the holding mechanism control section 32 causes the holding mechanism 20 and a separator roll 10 to rotate in the 0 direction, refers to an angle not larger than the angle with which (i) no uncaptured region is present on the a side surface of a frame-shaped separator 12 of the separator roll 10 when a plurality of regions R obtained by capturing images of the separator roll 10 while causing the holding mechanism 20 and the separator roll 10 to rotate by 360 degrees are so arranged as to overlap with each other and (ii) the captured region on the side surface of the frame-shaped separator 12 is the smallest.

This configuration makes it possible to efficiently capture an image of the entire separator 12 of the separator roll 10, which separator 12 is wound around the core 8. With the above configuration, the radiation source section 2 may preferably have an emitting surface 2a whose center 2b is so positioned as to face the sensor section 3. With this positioning, no uncaptured region being present on the second side surface 10c of a separator roll 10 means that no uncaptured region is present on the first side surface 10b as well. This makes it possible to capture an image of the entire separator roll 10 more suitably.

When the holding mechanism control section 32 has caused the holding mechanism 20 and the separator roll 10 to (i) rotate in the 0 direction by a predetermined angle and then (ii) stop, the inspection device 9 captures an image of the separator roll 10 as rotated.

Next, the sensor control section 33 extracts, from the captured image generated, a second region R2, which corresponds to the target region 3b.

The second region R2 and the first region R1 as rotated overlap with each other with no gap therebetween and are angled differently from each other.

The operation is repeated of, as described above, (i) capturing an image, (ii) causing the separator roll 10 to rotate in the θ direction by a predetermined angle, and (iii) extracting a region after the rotation which region corresponds to the target region 3b.

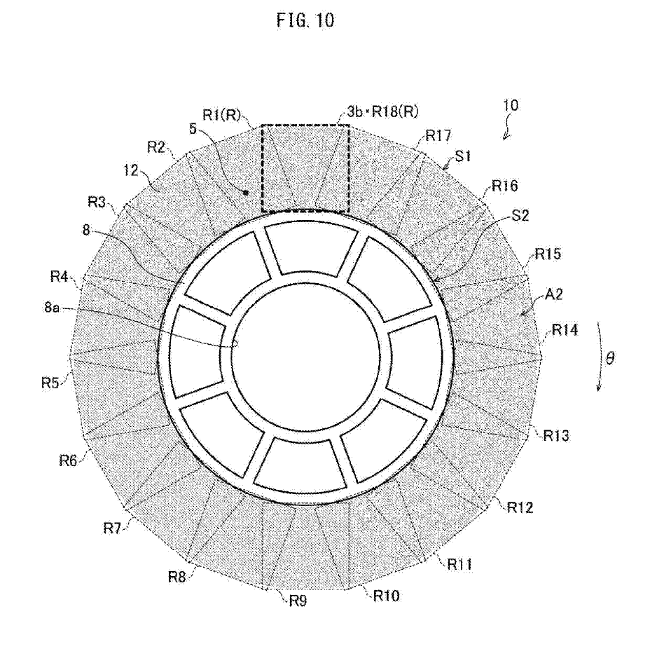

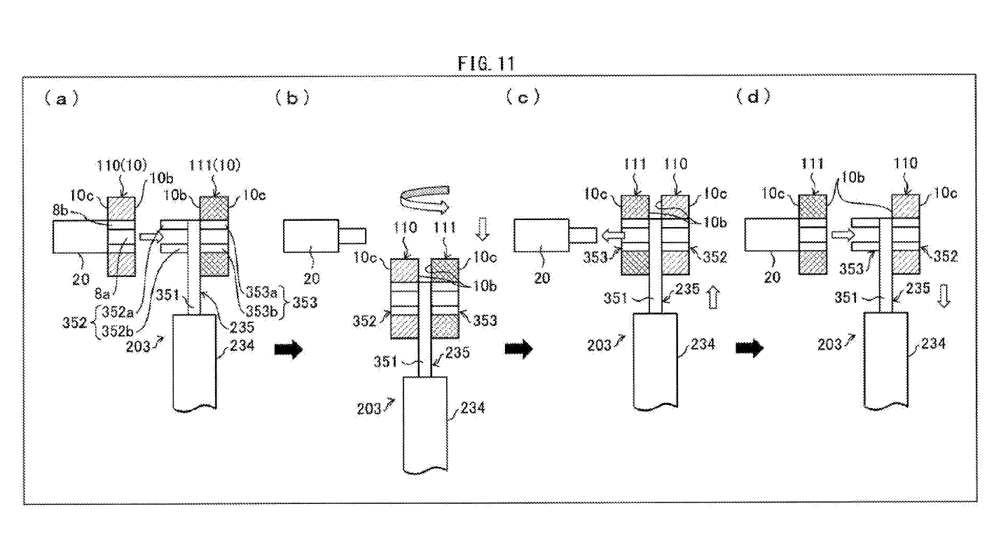

FIG. 10 is a diagram illustrating an inspection image of a separator roll in accordance with Embodiment 1.

FIG. 10 illustrates an inspection image including a first region R1 through an eighteenth region R18, the inspection image being a combination of respective images of regions each of which corresponds to the target region 3b and is extracted from the entire separator 12 having the shape of a ring. The separator 12 in the shape of a ring is shown in the combination of the first region R1 through the eighteenth region R18 (all the regions R).

The first region R1 through the eighteenth region R18 (all the regions R), which have been obtained by capturing images of the separator roll 10 while causing the holding mechanism 20 and the separator roll 10 to rotate by 360 degrees, have respective angles different from each other by a predetermined angle, which is not larger than the angle with which (i) no uncaptured region is present on the second side surface 10c of the separator roll 10 when the regions R adjacent to each other are so arranged as to overlap with each other and (ii) the number of images captured is the smallest.

With the holding mechanism 20 rotating in the 0 direction by a predetermined angle for each rotation as described above, the separator roll 10 is moved relative to the radiation source section 2 in such a manner that an image is obtained of the entire separator 12 wound around the core 8. This makes it possible to inspect the entire separator 12 for a defect.

The inspection device 9 may alternatively be configured such that the separator roll 10 is moved relative to the radiation source section 2 as the radiation source section 2 and the sensor section 3 are rotated in the θ direction by a predetermined angle for each rotation with the center of the separator roll 10 as the rotation center (the holding mechanism 20 is fixed).

The first region R1 through the eighteenth region R18 are arranged such that (i) no gap is present between adjacent regions and that (ii) the first region R1 through the eighteenth region R18 are angled differently from each other in such a manner that each overlapping portion has a minimum possible area.

The inspection device 9 is capable of generating an inspection image that combines images extracted of the entire separator 12 having the shape of a ring as described above.

The present embodiment is configured to generate an inspection image of the entire ring-shaped separator by carrying out, eighteen times, the flow of (i) capturing an image, (ii) extracting a target region 3b from the captured image, and (iii) causing the separator roll 10 to rotate in the 0 direction by a predetermined angle. The number of the repeated operations may be changed as appropriate.

The sensor control section 33 may be configured to then cause the inspection image to be displayed by a display (not shown in the drawings). The sensor control section 33 may also be configured to (i) for example, process the inspection image in order to determine whether there is any defect to be detected and (ii) notify the operator of the determination result.

As described above, the separator roll 10 is moved relative to the radiation source section 2, and the radiation source section 2 emits an electromagnetic wave 4 to the separator roll 10 before and after the relative movement.

The radiation source section 2 thus emits an electromagnetic wave 4 to a region of the separator roll 10 before the relative movement of the separator roll 10 and to a region of the separator roll 10 which region is different from the above region after the relative movement. This allows the sensor control section 33 to obtain a captured image of a region of the separator roll 10 before the relative movement of the separator roll 10 and a captured image of a region of the separator roll 10 which region is different from the above region after the relative movement.

The description above assumes that the radiation source section 2 emits an electromagnetic wave constantly. Alternatively, the emission of an electromagnetic wave 4 may be (i) stopped before the separator roll 10 is moved (that is, rotated by a predetermined angle) relative to the radiation source section 2 and (ii) restarted after the separator roll 10 is moved relative to the radiation source section 2. Further alternatively, the detection by the sensor section 3 may be stopped and restarted while the radiation source section 2 is emitting an electromagnetic wave 4 constantly.

The emission of an electromagnetic wave by the radiation source section 2 may be suspended while the robot arm 203 is replacing a separator roll 10 that the holding mechanism 20 is holding.

The above configuration can solve the problem caused by constant emission of an electromagnetic wave by the radiation source section 2.

The separator roll 10 is rotated relative to the radiation source section 2 with the center of the separator roll 10 as the rotation center. The sensor control section 33 generates a captured image of such a separator roll 10.

The sensor control section 33 combines a captured image generated before the relative movement of the separator roll 10 with a captured image generated after the relative movement of the separator roll 10 in such a manner that the two images partially overlap with each other. This configuration makes it possible to create a captured image of a wide area of the separator roll 10 thoroughly. This in turn makes it possible to efficiently create a captured image of a wide region of a separator roll 10.

The inspection device 9 may preferably be configured to obtain a captured image that also shows a portion of the core 8. This configuration makes it possible to create a captured image of a wide area of the separator roll 10 thoroughly, the wide area including the innermost portion (which is the closest to the core 8) of the separator 12 of the separator roll 10.

The inspection device 9 may preferably be configured to obtain a captured image that also shows a space outside the outer peripheral surface 10a of the separator roll 10. This configuration makes it possible to create a captured image of a wide area of the separator roll 10 thoroughly, the wide area including the outermost portion (which corresponds to the outer peripheral surface 10a of the separator roll 10) of the separator 12 of the separator roll 10.

The inspection device 9 uses the electromagnetic wave 4 as an electromagnetic wave that the radiation source section 2 emits. This configuration makes it relatively easy to check whether there is any defect inside a separator 12 wound around a core 8.

The inspection device 9 may be configured to capture a plurality of images of the same region of a separator roll 10 while changing the respective relative positions of the radiation source section 2 and the separator roll 10. Capturing a plurality of images (for example, two images) of the same region of a separator roll 10 while changing the respective angles of the radiation source section 2 and the separator roll 10 makes it possible to, for example, (i) specify the position of a foreign object in the separator roll 10 (that is, the TD position in the separator roll 10), (ii) specify the overall shape of a foreign object in the separator roll 10, and/or (iii) detect a thin foreign object.

The inspection device 9 may be configured to, when capturing a second image of the separator roll 10, capture an image of the entire separator roll 10 again or alternatively capture an image of only a necessary region of the separator roll 10. For instance, after the inspection device 9 captures an image of the entire separator roll 10 by a method described above with reference to FIGS. 8 to 10, the inspection device 9 may (i) specify, from the captured image, a region of the separator roll 10 in which region a foreign object is contained or something that looks like a foreign object is shown and (ii) capture an image again of only that region of the separator roll 10.

In a case where a separator roll 10 contains a particularly small (thin) foreign object, capturing only one image of the separator roll 10 may not be sufficient to find the foreign object. Thus, in a case where a foreign object as an inspection target is particularly small (thin), the inspection device 9 may preferably capture a plurality of images of the entire separator roll 10 while changing the respective angles of the radiation source section 2 and the separator roll 10. This makes it possible to detect a small (thin) foreign object.

The inspection device 9 is capable of, on the basis of, for example, the time length necessary to inspect a single separator roll 10, the sensitivity of the sensor section 3, and/or the number of products to be processed (that is, the number of separator rolls 10 to be inspected), being set to detect a foreign object 5 having a size within a particular range.

For instance, setting the inspection device 9 to detect any foreign object 5 that is not less than 100 μm and using the inspection device 9 for defect inspection of a separator roll 10 makes it possible to select, from among various separator rolls 10 that are produced through a process of producing a separator roll 10 and that (possibly) contain foreign objects of various sizes, any separator roll 10 that contains a foreign object 5 that is not less than 100 μm.

Removing, during the production process, any separator roll 10 in which the inspection device 9 has detected a foreign object 5 that is not less than 100 μm makes it possible to select, from among various separator rolls 10 (possibly) contain foreign objects of various sizes, any separator roll 10 that contains only a small number of foreign objects 5 which are not less than 100 μm or that is free from any foreign object 5 which is not less than 100 μm.

Stated differently, including, in the process of producing a separator roll 10, a defect inspection step involving the use of the inspection device 9 makes it possible to produce, from among various separator rolls 10 (possibly) containing foreign objects of various sizes, a separator roll 10 that contains only a small number of foreign objects 5 which are not less than 100 μm or that is free from any foreign object 5 which is not less than 100 μm.

In particular, a separator roll 10 containing only a small number of foreign objects 5 that are not less than 100 μm has a low possibility that a foreign object 5 adhering to the separator 12 causes a failure of the separator 12 or a failure of a battery including such a separator.

Including, in the process of producing a separator roll 10, a defect inspection step involving the use of the inspection device 9 as described above makes it possible to produce a separator roll that has only a small number of defects such as entry of a foreign object 5.

The defect inspection step may, as described above, preferably be carried out after the slitting step and before the packaging step during the process of producing a separator roll 10. This configuration makes it possible to efficiently inspect a separator roll 10 for any foreign object 5 generated in the slitting step.

Including the defect inspection step in the process of producing a separator roll 10 eliminates the need to inspect a separator 12 for an adhering foreign object 5 after the step of packaging the separator roll 10, specifically during a production process of assembling a battery with use of the separator 12 wound around the core 8.

The control section 30 may preferably be configured to, after an image is captured of a separator roll 10 and before an image is captured of another separator roll 10 (that is, after the end of each image-capturing cycle), return each section moved for capturing an image of the separator roll 10 (such as the holding mechanism 20) to its initial state. This prevents an inspection failure, a redundant inspection, and a malfunction such as starting an image-capturing operation while the previous image-capturing operation has not finished.

(Details of Robot Arm)

FIG. 11 is a diagram schematically illustrating the configuration and an operating state of the robot arm 203 of Embodiment 1. Specifically, (a) of FIG. 11 illustrates an operating state of the robot arm 203 in which operating state while holding a separator roll 111 which has not been inspected, the robot arm 203 withdraws, from the holding mechanism 20 of the inspection device 9, a separator roll 110 which has been inspected. (b) of FIG. 11 illustrates an operating state of the robot arm 203 in which operating state the robot arm 203 causes the hand part 235 to rotate. (c) of FIG. 11 illustrates an operating state of the robot arm 203 in which operating state the robot arm 203 sets, on the holding mechanism 20, the separator roll 111 which has not been inspected. (d) of FIG. 11 illustrates an operating state of the robot arm 203 which has set, on the holding mechanism 20, the separator roll 111 which has not been inspected.

As illustrated in (a) through (d) of FIG. 11, the robot arm 203 is configured to be capable of simultaneously holding the plurality of separator rolls 10. The hand part 235 of the robot arm 203 has a basal part 351 which is shaped so as to have a longitudinal direction, and a first gripping part 352 and a second gripping part 353 each provided to the basal part 351.

The basal part 351 is connected to the second arm part 234, and the first gripping part 352 and the second gripping part 353 are provided to a tip (a first end opposite a second end at which the second arm part 234 is located) of the basal part 351 so as to be substantially symmetric with respect to the basal part 351. The configuration allows the robot arm 203 in accordance with Embodiment 1 to hold two separator rolls 10 in parallel.

The first gripping part 352 includes a pair of finger parts 352a and 352b. The first gripping part 352 holds the core 8 of a separator roll 10 by changing an interval between the pair of finger parts 352a and 352b. Similarly, the second gripping part 353 includes a pair of finger parts 353a and 353b. The second gripping part 353 holds the core 8 of a separator roll 10 by changing an interval between the pair of finger parts 353a and 353b. Note that neither the first gripping part 352 nor the second gripping part 353 necessarily needs to include a pair of finger parts and that each of the first gripping part 352 and the second gripping part 353 may include three or more finger parts.

The first gripping part 352 and the second gripping part 353 may, for prevention of generation of a metal foreign object, preferably be configured such that its sliding section is made of resin. The resin is not limited to any kind. Examples of the resin include: a general-purpose resin such as polyethylene resin, polypropylene resin, polystyrene resin, vinyl chloride resin, acrylic resin, ABS, or polyester; an engineering plastic such as polyacetal, polyamide, polycarbonate, or modified polyphenylene ether; and a super engineering plastic such as polyalylate, polysulfone, polyether sulfone, polyphenylene sulfide, polyether ether ketone, polyimide, or polyetherimide. Among the above resins, the resin is preferably a high-strength super engineering plastic, and more preferably polyether ether ketone.

Alternatively, each of the first gripping part 352 and the second gripping part 353 may be subjected to a urethane lining process. This makes it possible to achieve, without damaging the core 8, the first gripping part 352 and the second gripping part 353 each of which is less slippery and in each of which a metal foreign object is less likely to be generated.

Each of the first gripping part 352 and the second gripping part 353 has a hardness of preferably not less than A70 and not more than A90, and more preferably A70. The first gripping part 352 and the second gripping part 353 each of which has a hardness of more than A90 are so hard as to be slippery. Meanwhile, the first gripping part 352 and the second gripping part 353 each of which has a hardness of less than A70 easily cause poor chucking.

According to Embodiment 1, the robot arm 203 holds the separator roll 10 by inserting the first gripping part 352 (the pair of finger parts 352a and 352b) or the second gripping part 353 (the pair of finger parts 353a and 353b) in respective second through holes 8b of the core 8 from the side of the first side surface 10b of the separator roll 10. The inspection device 9 holds the separator roll 10 by inserting the holding mechanism 20 in the first through hole 8a of the core 8 from the side of the second side surface 10c of the separator roll 10.

As illustrated in (a) of FIG. 11, the robot arm 203 withdraws the separator roll 110 (separator roll 10 which has been inspected) from the holding mechanism 20 by causing the first gripping part 352 to hold, from the side of the first side surface 10b, the separator roll 110 which is held by the holding mechanism 20 from the side of the second side surface 10c.

Next, as illustrated in (b) of FIG. 11, the robot arm 203 which has withdrawn the separator roll 110 temporarily moves backward so as to cause the hand part 235 to rotate 180 degrees. This allows the separator roll 111 (separator roll 10 which has not been inspected) which is held by the second gripping part 353 to be located beside the holding mechanism 20.

Subsequently, as illustrated in (c) of FIG. 11, the robot arm 203 (i) moves forward to a place at which the separator roll 111 faces the holding mechanism 20 and (ii) sets the separator roll 111 on the holding mechanism 20. In this case, the robot arm 203 sets the separator roll 111 on the holding mechanism 20 by inserting the holding mechanism 20 in the first through hole 8a of the core 8 from the side of the second side surface 10c of the separator roll 111.

Then, as illustrated in (d) of FIG. 11, the robot arm 203 which has set the separator roll 111 on the holding mechanism 20 moves backward to an outside of the first chamber 41. After the robot arm 203 has moved to the outside of the first chamber 41, a defect inspection is carried out with respect to the separator roll 111 which has been set on the holding mechanism 20.

The first blocking section 51 may be closed every time the defect inspection is carried out with respect to the separator roll 111. Alternatively, the first blocking section 51 may be closed at a certain timing at which the defect inspection is temporarily stopped. This is because the second chamber 42 is provided which is different from the first chamber 41 in which to carry out the defect inspection with respect to the separator roll 111.

As described earlier, Embodiment 1 is configured such that the robot arm 203 holds the core 8 from the side of the first side surface 10b of the separator roll 10, and the holding mechanism 20 of the inspection device holds the core 8 from the side of the second side surface 10c of the separator roll 10. Since the robot arm 203 and the inspection device 9 thus hold the core 8 from the sides of the respective different side surfaces of the separator roll 10, the separator roll 10 can be efficiently transferred between the robot arm 203 and the inspection device 9.

Further, since each of the robot arm 203 and the holding mechanism 20 of the inspection device 9 holds the core 8 of the separator roll 10, the separator roll 10 can be transferred without a direct contact of each of the robot arm 203 and the inspection device 9 with the separator 12 wound around the core 8.

In addition, the robot arm 203 holds the separator roll 10 by inserting the first gripping part 352 and the second gripping part 353 in the respective second through holes 8b of the core 8, and the inspection device 9 holds the separator roll 10 by inserting the holding mechanism 20 in the first through hole 8a of the core 8. Since the robot arm 203 and the inspection device 9 thus hold respective different parts of the core 8, the separator roll 10 can be more efficiently transferred between the robot arm 203 and the inspection device 9.

According to Embodiment 1, the robot arm 203 is configured to be capable of holding two separator rolls 10. Note, however, that the robot arm 203 does not necessarily need to be thus configured. The robot arm 203 may be configured to hold one (1) separator roll 10, or may be configured to hold three or more separator rolls 10.

Note that an aspect of the present invention may be configured such that (i) the first gripping part 352 and the second gripping part 353 of the robot arm 203 hold the first through hole 8a of the core 8 and (ii) the holding member(s) 221 of each of the racks 201 and 202 and the holding mechanism 20 of the inspection device 9 hold the second through holes 8b of the core 8.

### Embodiment 2

The description below deals with Embodiment 2 of the present invention. Note that for convenience of explanation, identical reference numerals are given to members which have respective functions identical with those described in Embodiment 1, and descriptions of the respective members are not repeated here.

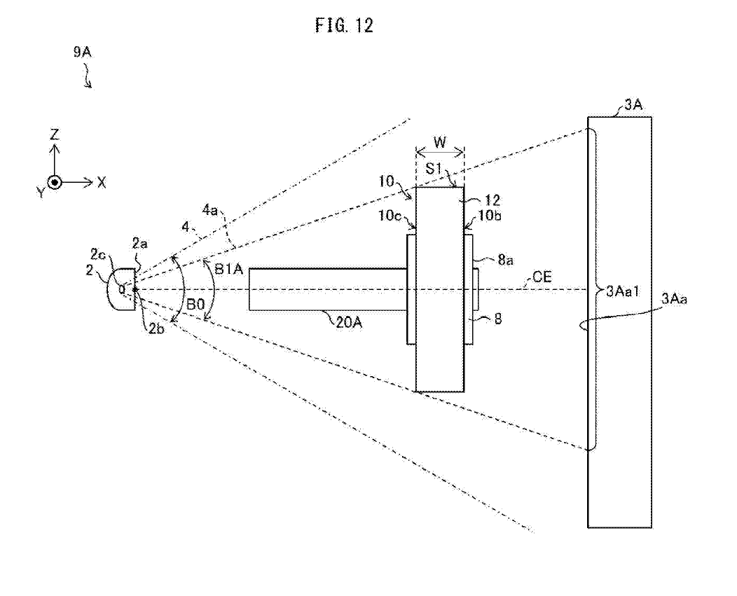

FIG. 12 is a diagram schematically illustrating the configuration of an inspection device 9A in accordance with Embodiment 2. An inspection system 1 (e.g., FIG. 3) may include the inspection device 9A instead of the inspection device 9.

The inspection device 9A includes a sensor section 3A and a holding mechanism 20A in place of the sensor section 3 and the holding mechanism 20 of the inspection device 9.

The sensor section 3A is larger than the sensor section 3, and has a detecting surface 3Aa large enough to form an image of the entire separator roll 10. The sensor section 3A may be configured to include a plurality of sensor sections 3.

The holding mechanism 20A is identical to the holding mechanism 20 except that the holding mechanism 20A does not include a motor configured to rotate in the 0 direction. The holding mechanism 20A does not cause a separator roll 10 that the holding mechanism 20A is holding to rotate in the 0 direction. This is because the holding mechanism 20A does not need to move (for example, rotate) a separator roll 10 in order to capture an image of the entire separator 12 of the separator roll 10, since the detecting surface 3Aa of the sensor section 3A is large enough to form an image of the entire separator roll 10.

The holding mechanism 20A is capable of, in response to an instruction from the holding mechanism control section 32 (FIG. 3), moving in the X-axis direction and the Z-axis direction. The holding mechanism 20A may be configured to be capable of moving also in the Y-axis direction, which is perpendicular to the X-axis direction and the Z-axis direction.

The radiation source section 2 is so positioned as to have an emitting surface 2a with a center line CE coinciding with the central axis of the holding mechanism 20A. This configuration allows (i) an electromagnetic wave 4 emitted by the radiation source section 2 to uniformly strike the separator roll 10 which is held by the holding mechanism 20A and (ii) the electromagnetic wave 4 having passed through the separator roll 10 to be detected by the sensor section 3A at the detecting surface 3Aa.

The sensor control section 33 (FIG. 3) is configured to generate a captured image of the entire separator roll on the basis of electric signals obtained by the sensor section 3A detecting electromagnetic waves 4.

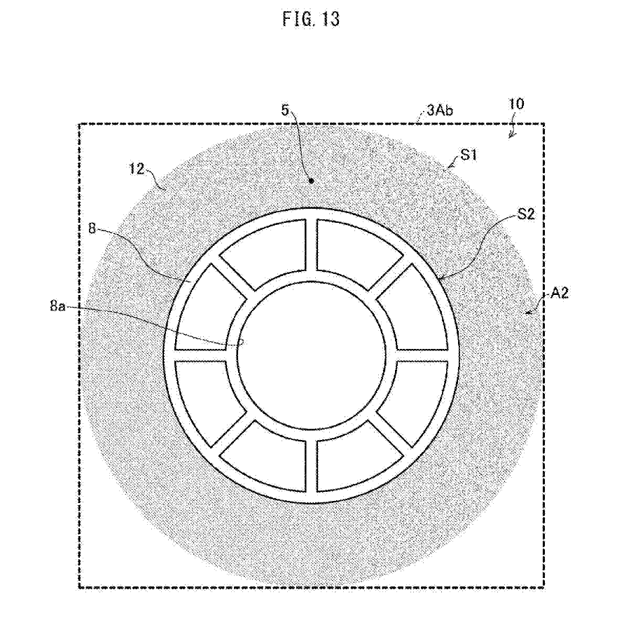

FIG. 13 is a diagram illustrating an inspection image of a separator roll in accordance with Embodiment 2 of the present invention.

As illustrated in FIG. 13, the sensor control section 33 (FIG. 3) is configured to obtain an inspection image 3Ab, which is obtained by removing an unnecessary portion of the captured image which unnecessary portion is present around the region corresponding to the separator roll 10.

The inspection image 3Ab has a dimension in the up-down direction which dimension, as illustrated in FIG. 12, extends in the up-down direction along a detecting surface 3Aa1 (that is, a portion of the detecting surface 3Aa of the sensor section 3A) which detecting surface 3Aa1 an electromagnetic wave 4a among other electromagnetic waves 4 strikes through a separator roll 10, the electromagnetic wave 4a being emitted radially with an angle B1A with the center line CE as the center which angle B1A covers the outer peripheral surface of the second side surface 10c of the separator roll 10.

### Embodiment 3

The description below deals with Embodiment 3 of the present invention. Note that for convenience of explanation, identical reference numerals are given to members which have respective functions identical with those described in Embodiment 1 or 2, and descriptions of the respective members are not repeated here.

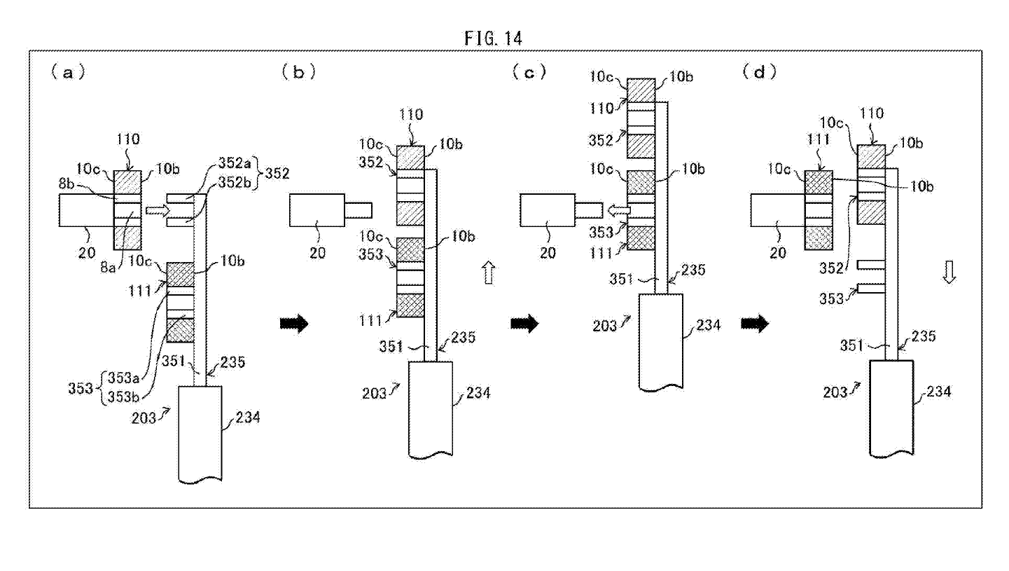

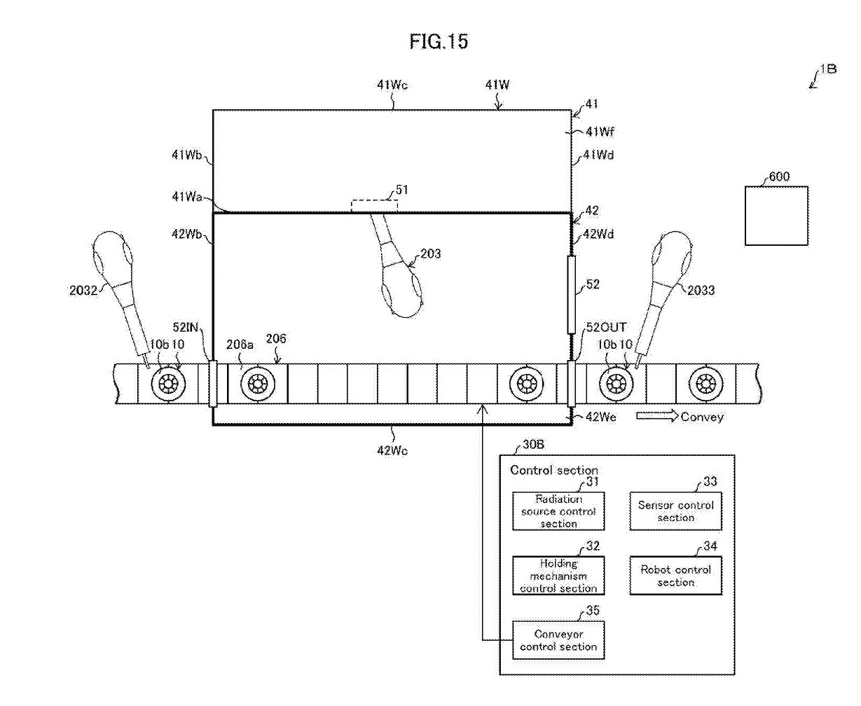

FIG. 14 is a diagram schematically illustrating the configuration and an operating state of a robot arm of Embodiment 3. (a) of FIG. 14 illustrates an operating state of a robot arm 203 in which operating state while holding a separator roll 111 which has not been inspected, the robot arm 203 withdraws, from a holding mechanism 20 of an inspection device 9, a separator roll 110 which has been inspected. (b) of FIG. 14 illustrates an operating state of the robot arm 203 in which operating state the robot arm 203 moves, toward the holding mechanism 20, the separator roll 111 which has not been inspected and is held by a second gripping part 353 of a hand part 235. (c) of FIG. 14 illustrates an operating state of the robot arm 203 in which operating state the robot arm 203 sets, on the holding mechanism 20, the separator roll 111 which has not been inspected. (d) of FIG. 14 illustrates an operating state of the robot arm 203 which has set, on the holding mechanism 20, the separator roll 111 which has not been inspected.

As illustrated in (a) through (d) of FIG. 14, the robot arm 203 may include the hand part 235 which has a first gripping part 352 and the second gripping part 353 which are provided so as to face the holding mechanism 20 and be parallel to the longitudinal direction of a basal part 351. The configuration allows the robot arm 203 to hold two separator rolls 10 in series.

As illustrated in (a) of FIG. 14, the robot arm 203 which includes the hand part 235 described above withdraws the separator roll 110 from the holding mechanism 20 by causing the first gripping part 352 to hold, from a side of a first side surface 10b, the separator roll 110 which is held by the holding mechanism 20 from a side of a second side surface 10c.

Subsequently, as illustrated in (b) and (c) of FIG. 14, the robot arm 203 which has withdrawn the separator roll 110 (i) moves forward to a place at which the separator roll 111 which is held by the second gripping part 353 faces the holding mechanism 20 and (ii) sets the separator roll 111 on the holding mechanism 20.

Then, as illustrated in (d) of FIG. 14, the robot arm 203 which has set the separator roll 111 on the holding mechanism 20 moves backward to an outside of a first chamber 41. After the robot arm 203 has moved to the outside of the first chamber 41, a defect inspection is carried out with respect to the separator roll 111.

A first blocking section 51 may be closed every time the defect inspection is carried out with respect to the separator roll 111. Alternatively, the first blocking section 51 may be closed at a certain timing at which the defect inspection is temporarily stopped. This is because a second chamber 42 is provided which is different from the first chamber 41 in which to carry out the defect inspection with respect to the separator roll 111.

The configuration in which the robot arm 203 thus holds a plurality of separator rolls 10 is exemplified by but not particularly limited to (i) a configuration in which the robot arm 203 holds a plurality of separator rolls 10 in parallel, (ii) a configuration in which the robot arm 203 holds a plurality of separator rolls 10 in series, and (iii) a combination of the configurations (i) and (ii).

### Embodiment 4

The description below deals with Embodiment 4 of the present invention. Note that for convenience of explanation, identical reference numerals are given to members which have respective functions identical with those described in any of Embodiments 1 to 3, and descriptions of the respective members are not repeated here.

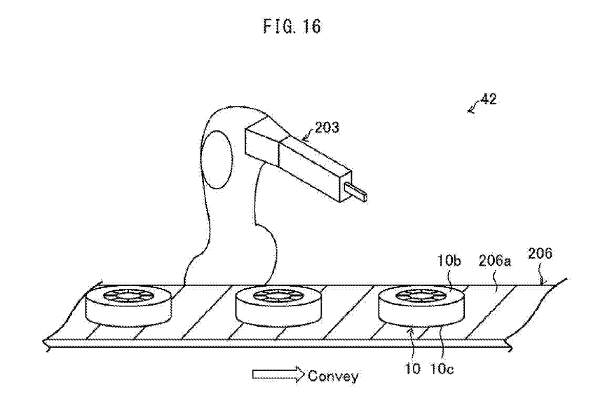

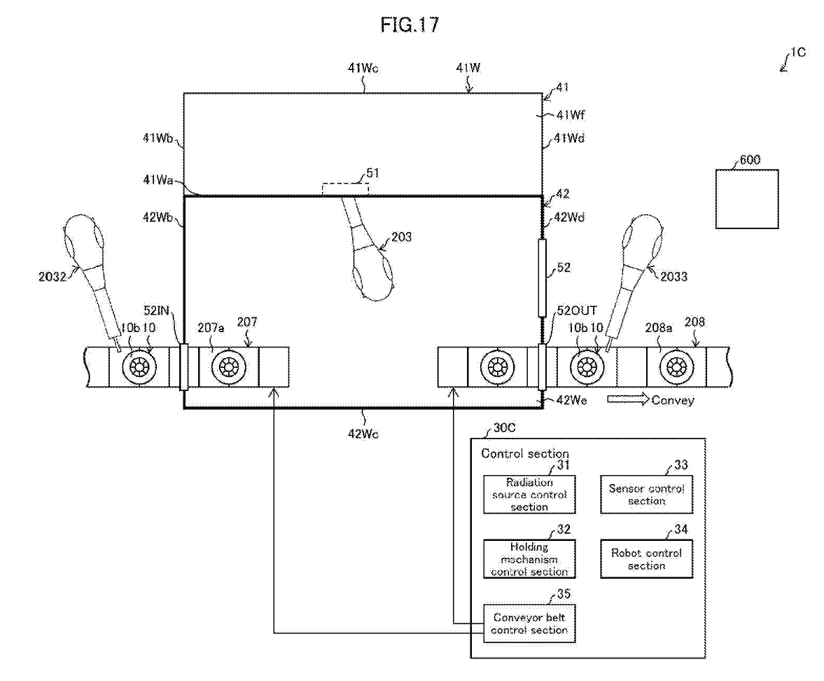

FIG. 15 is a planar diagram schematically illustrating the configuration of an inspection system 1B in accordance with Embodiment 4. FIG. 16 is a perspective view of a belt conveyor 206 and a robot arm 203 of the inspection system 1B in accordance with Embodiment 4.

The inspection system 1B includes the belt conveyor (stocking mechanism) 206 and a control section 30B in place of the racks 201 and 202 and the control section 30 of the inspection system 1 (FIG. 3). A wall 42W, by which a second chamber 42 of the inspection system 1B is surrounded, includes (i) a sidewall 42Wb which is provided with a second blocking section 52IN and (ii) a sidewall 42Wd which is provided with a second blocking section 52OUT. The inspection system 1B includes, in place of the robot arm 2031, robot arms 2032 and 2033 which are provided outside the second chamber 42. The inspection system 1B is otherwise similar in configuration to the inspection system 1.

The control section 30B is obtained by causing the control section 30 to further include a conveyor control section 35 configured to control driving of the belt conveyor 206.

The belt conveyor 206 is a stocking mechanism for stocking a separator roll 10 which has not been inspected and a separator roll 10 which has been inspected.

On the belt conveyor 206, the separator roll 10 (111) which has not been inspected and the separator roll 10 (110) which has been inspected are placed. Embodiment 4 uses the belt conveyor as the stocking mechanism. Note, however, that examples of a conveyor that can be replaced with the belt conveyor include various conveyors such as a chain conveyor, a roller conveyor, and a screw conveyor.

The belt conveyor 206 extends so as to pass through the second chamber 42. This allows (i) the separator roll 10 which has not been inspected to be easily carried into the second chamber 42 and (ii) the separator roll 10 which has been inspected to be easily carried out of the second chamber 42. The separator roll 10 (111) which has not been inspected can be placed on the belt conveyor 206 with use of the robot arm 2032 before being carried into the second chamber 42. The separator roll 10 (110) which has been inspected and is placed on the belt conveyor 206 can be conveyed with use of the robot arm 2033 after being carried out of the second chamber 42. In this case, the separator roll 10 (110) which has been inspected may be placed, by means of the robot arm 2033, in a packaging device 600 which is provided outside the second chamber 42. Packaging a separator roll(s) 10 immediately after inspection can prevent a new foreign object from adhering to the separator roll(s) 10. The robot arms 2032 and 2033 can each have a configuration identical to that of the robot arm 203.

The belt conveyor 206 extends from outside the second chamber 42 to inside the second chamber 42 by passing through the second blocking section 52IN which is provided on the sidewall 42Wb. The belt conveyor 206 which extends across the second chamber 42 extends from inside the second chamber 42 to outside the second chamber 42 by passing through the second blocking section 52OUT which is provided on the sidewall 42Wd.

The second blocking sections 52IN and 52OUT can each be structured to, while allowing the belt conveyor 206 and a separator roll 10 which is placed on the belt conveyor 206 to pass therethrough, make it possible to prevent an electromagnetic wave that a radiation source section 2 emits from leaking outside the second chamber 42.

For example, the second blocking sections 52IN and 52OUT can each be structured to have a wall which is provided with a through hole which is covered with a curtain. In a case where the electromagnetic wave that the radiation source section 2 emits is X rays, the curtain preferably contains lead.

A structure with which to cover the through hole may be a door (e.g., a horizontally sliding door or a vertically sliding door) or may be a door which is provided with a curtain which prevents an electromagnetic wave from leaking through a gap in the door.

The second blocking sections 52IN and 52OUT may each be structured to be a front chamber which has two openings. In this case, the openings may each be provided with a curtain and/or a door which have/has been taken as an example(s) of the structure of the through hole.

The belt conveyor 206 has a holding surface (placement surface) 206a on which to hold (place) a separator roll 10. The belt conveyor 206 conveys the separator roll 10 while causing the holding surface 206a to hold a side of a second side surface 10c of the separator roll 10. Embodiment 4 is preferably configured such that a separator 12 is wound around an outer circumferential surface 81a of a core 8 of the separator roll 10 so that a side surface of the core 8 is closer to the holding surface 206a than a side surface of the separator 12 on the side of the second side surface 10c of the separator roll 10. With the configuration, the belt conveyor 206 can convey the separator roll 10, without coming into direct contact with the separator 12, while causing the holding surface 206a to hold the core 8 of the separator roll 10.

The inspection system 1B is configured to intermittently drive the belt conveyor 206 so as to cause a separator roll 10 to travel a predetermined distance. The robot arm 203 holds, from a side of a first side surface 10b of a separator roll 10 which has been conveyed by the belt conveyor 206 and has not been inspected, the core 8 of the separator roll 10, and carries the separator roll 10 into an inspection device 9. The robot arm 203 holds the core 8 from the side of the first side surface 10b of the separator roll 10 which has been inspected, and places the separator roll 10 on the belt conveyor 206 while causing the second side surface 10c of the separator roll 10 to face the holding surface 206a. The inspection system 1B is thus configured to repeatedly carry out an operation to inspect the separator roll 10 for a foreign object by driving the belt conveyor 206 so as to cause the separator roll 10 to travel a predetermined distance.

Note that the holding surface 206a of the belt conveyor 206 may be provided with a protrusion by which to support the separator roll 10 at a distance from the holding surface 206a. The configuration makes it possible to more reliably prevent the separator 12 from coming into contact with the holding surface 206a. The configuration also makes it possible to prevent the separator roll 10 on the belt conveyor 206 (holding surface 206a) from being positionally displaced due to vibrations generated in association with operation of the belt conveyor 206.

As described earlier, the inspection system 1B in accordance with Embodiment 4 is configured such that the robot arm 203 holds the core 8 of the separator roll 10 from the side of the first side surface 10b of the separator roll 10, and the belt conveyor 206 holds the core 8 of the separator roll 10 from the side of the second side surface 10c of the separator roll 10.

Since the robot arm 203 and the belt conveyor 206 thus hold the core 8 of the separator roll 10 from the sides of the respective different side surfaces of the separator roll 10, the separator roll 10 can be efficiently transferred between the robot arm 203 and the belt conveyor 206 without a direct contact of each of the robot arm 203 and the belt conveyor 206 with the separator 12 wound around the core 8.

Further, by using the belt conveyor 206 as the stocking mechanism, it is possible to automatically convey a separator roll 10 which has not been inspected and a separator roll 10 which has been inspected, and consequently to reduce a tact time required for production of the separator 12.

### Embodiment 5

The description below deals with Embodiment 5 of the present invention. Note that for convenience of explanation, identical reference numerals are given to members which have respective functions identical with those described in any of Embodiments 1 to 4, and descriptions of the respective members are not repeated here.

FIG. 17 is a planar diagram schematically illustrating the configuration of an inspection system 1C in accordance with Embodiment 5.

The inspection system 1C includes belt conveyors (stocking mechanisms) 207 and 208 in place of the belt conveyor 206 of the inspection system 1B (FIG. 15). The belt conveyors 207 and 208 are obtained by separating the belt conveyor 206 in the second chamber 42. The inspection system 1C is otherwise similar in configuration to the inspection system 1B.

The belt conveyor 207 extends from outside the second chamber 42 through a second blocking section 52IN to inside the second chamber 42. In the second chamber 42, the belt conveyor 207 and the belt conveyor 208 are provided so as to be spaced. The belt conveyor 208 extends from inside the second chamber 42 through a second blocking section 52OUT to outside the second chamber 42.

These belt conveyors 207 and 208 also allow (i) a separator roll 10 which has not been inspected to be easily carried into the second chamber 42 and (ii) a separator roll 10 which has been inspected to be easily carried out of the second chamber 42. The separator roll 10 (111) which has not been inspected can be placed on the belt conveyor 207 with use of a robot arm 2032 before being carried into the second chamber 42. The separator roll 10 (110) which has been inspected and is placed on the belt conveyor 208 can be conveyed with use of a robot arm 2033 after being carried out of the second chamber 42. In this case, the separator roll 10 (110) which has been inspected may be placed, by means of the robot arm 2033, in a packaging device 600 which is provided outside the second chamber 42. Packaging a separator roll(s) 10 immediately after inspection can prevent a new foreign object from adhering to the separator roll(s) 10.

The belt conveyor 207 is a stocking mechanism for stocking a separator roll 10 (111) which has not been inspected. A specific configuration of the belt conveyor 207 is substantially identical to the configuration of the belt conveyor 206 described earlier.

The belt conveyor 207 conveys the separator roll 10 while causing a holding surface 207a thereof to hold a core 8 of the separator roll 10 from a side of a second side surface 10c of the separator roll 10. The robot arm 203 holds the core 8 from a side of a first side surface 10b of the separator roll 10 which has not been inspected and is conveyed by the belt conveyor 207, and carries the separator roll 10 into an inspection device 9.

The belt conveyor 208 is a stocking mechanism for stocking a separator roll 10 (110) which has been inspected. A specific configuration of the belt conveyor 208 is substantially identical to the configuration of the belt conveyor 206 described earlier.

The belt conveyor 208 conveys the separator roll 10 while causing a holding surface 208a thereof to hold the core 8 of the separator roll 10 from the side of the second side surface 10c of the separator roll 10. The robot arm 203 holds the core 8 from the side of the first side surface 10b of the separator roll 10 which has been inspected, and places the separator roll 10 on the belt conveyor 208 while causing the second side surface 10c of the separator roll 10 to face the holding surface 208a.

As described earlier, the inspection system 1C in accordance with Embodiment 5 is configured such that the robot arm 203 holds the core 8 from the side of the first side surface 10b of the separator roll 10, and each of the belt conveyor 207 and the belt conveyor 208 holds the core 8 from the side of the second side surface 10c of the separator roll 10.

As described above, since the robot arm 203 holds the core 8 of the separator roll 10 from a side of a side surface of the separator roll 10 and each of the belt conveyor 207 and the belt conveyor 208 holds the core 8 of the separator roll 10 from a side of a side surface, different from the above side surface, of the separator roll 10, the separator roll 10 can be efficiently transferred between (a) the robot arm 203 and (b) each of the belt conveyor 207 (on which the separator roll 10 which has not been inspected is placed) and the belt conveyor 208 (on which the separator roll 10 which has been inspected is placed) without a direct contact of each of the robot arm 203, the belt conveyor 207, and the belt conveyor 208 with a separator 12 wound around the core 8.

Further, by using each of the belt conveyor 207 and the belt conveyor 208 as the stocking mechanism, the separator roll 10 (e.g., the separator roll 10 which has been inspected) can be carried immediately so as to be subjected to a subsequent step. This makes it possible to reduce a tact time required for production of the separator 12. Alternatively, as the stocking mechanism, a rack and a belt conveyor may be used in combination.

### Embodiment 6

The description below deals with Embodiment 6 of the present invention. Note that for convenience of explanation, identical reference numerals are given to members which have respective functions identical with those described in any of Embodiments 1 to 5, and descriptions of the respective members are not repeated here.

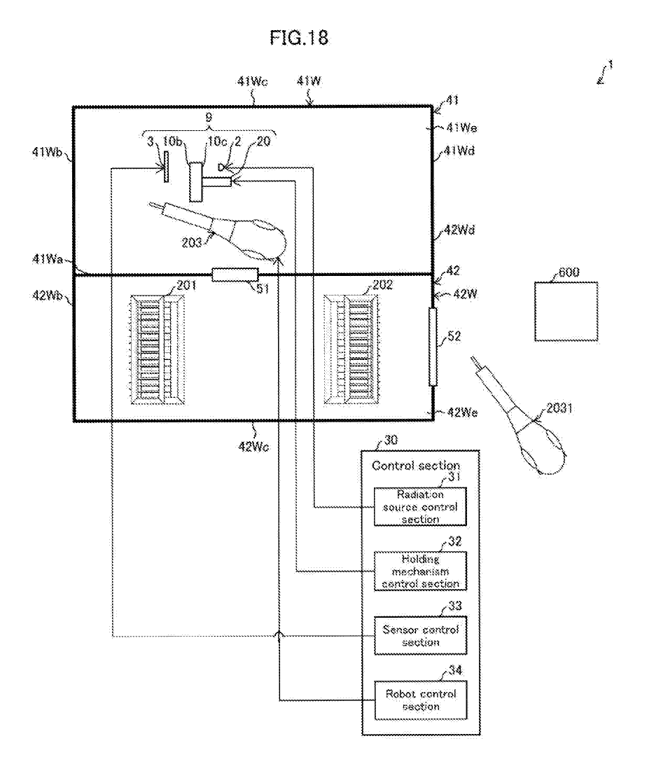

FIG. 18 is a planar diagram schematically illustrating the configuration of an inspection system 1 in accordance with Embodiment 6. As illustrated in FIG. 18, the inspection system 1 may be configured such that a robot arm 203 is provided not in a second chamber 42 but in a first chamber 41.

This makes it unnecessary to provide the robot arm 203 between a rack 201 and a rack 202. Thus, as compared with the inspection system 1 illustrated in FIG. 3, the inspection system 1 illustrated in FIG. 18 may make the rack 201 and the rack 202 closer to each other. Such a configuration allows a shorter length of a direction in which the rack 201 and the rack 202 are arranged in the second chamber 42, so that the second chamber 42 can be made compact.

### Embodiment 7

The description below deals with Embodiment 7 of the present invention. Note that for convenience of explanation, identical reference numerals are given to members which have respective functions identical with those described in any of Embodiments 1 to 6, and descriptions of the respective members are not repeated here.

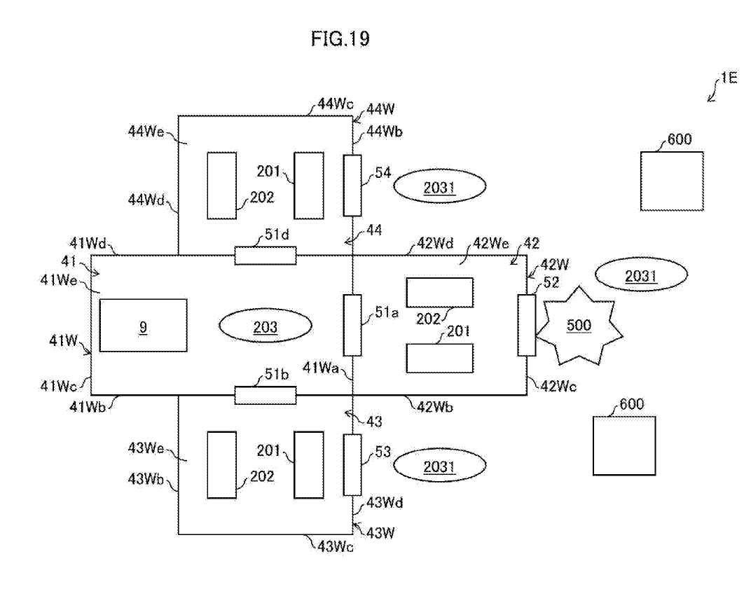

As illustrated in FIGS. 19 to 22, a plurality of front chambers in each of which either a separator roll 10 to be inspected or a separator roll 10 having been inspected is stocked may be provided.

FIG. 19 is a planar diagram illustrating the configuration of an inspection system 1E in accordance with Embodiment 7. The inspection system 1E includes not only a first chamber 41 and a second chamber 42 but also a third chamber 43 and a fourth chamber 44.

The inspection system 1E includes an inspection device 9 and a robot arm 203 which are provided in the first chamber 41.

The third chamber 43 is surrounded by (i) a wall 43W that blocks an electromagnetic wave that a radiation source section 2 provided in the first chamber emits and (ii) a sidewall 41Wb. The wall 43W includes sidewalls 43Wb to 43Wd, a floor 43We, and a ceiling (not illustrated). The sidewalls 43Wb to 43Wd stand on the floor 43We. The sidewalls 41Wb and 43Wc face each other. The sidewalls 43Wb and 43Wd face each other. The ceiling is supported by the sidewalls 41Wb and 43Wb to 43Wd and faces the floor 43We.

The sidewall 41Wb is shared by the first chamber and the third chamber 43 and separates the first chamber 41 and the third chamber 43 from each other. The sidewall 43Wd is provided with a third door 53 that serves to separate the third chamber 43 and outside space from each other.

The fourth chamber 44 is surrounded by (i) a wall 44W that blocks an electromagnetic wave that the radiation source section 2 provided in the first chamber emits and (ii) the sidewall 41Wd. The wall 44W includes sidewalls 44Wb to 44Wd, a floor 44We, and a ceiling (not illustrated). The sidewalls 44Wb to 44Wd stand on the floor 44We. The sidewalls 41Wd and 44Wc face each other. The sidewalls 44Wb and 44Wd face each other. The ceiling is supported by the sidewalls 41Wd and 44Wb to 44Wd and faces the floor 44We.

The sidewall 41Wd is shared by the first chamber 41 and the fourth chamber 44 and separates the first chamber 41 and the fourth chamber 44 from each other. The sidewall 44Wb is provided with a fourth door 54 that serves to separate the fourth chamber 44 and outside space from each other.

The first chamber 41 of the inspection system 1E is provided with a plurality of first blocking sections 51a, 51b, and 51d. The first blocking section 51a is provided on the sidewall 41Wa and separates the first chamber 41 and the second chamber 42 from each other. The first blocking section 51b is provided on the sidewall 41Wb and separates the first chamber 41 and the third chamber 43 from each other. The first blocking section 51d is provided on the sidewall 41Wd and separates the first chamber 41 and the fourth chamber 44 from each other.

The first blocking sections 51a, 51b, and 51d block an electromagnetic wave that the radiation source section 2 emits. A second blocking section 52, the third door 53, and the fourth door 54 each also preferably blocks an electromagnetic wave that the radiation source section 2 emits.

Note that according to Embodiment 7, the second blocking section 52, which is provided on the sidewall 42Wc, is parallel to the first blocking section 51a.

The inspection system 1E is configured such that a rack 201 and a rack 202 are provided in each of the second chamber 42, the third chamber 43, and the fourth chamber 44. Furthermore, robot arms 2031 are provided so as to correspond to the second chamber 42, the third chamber 43, and the fourth chamber 44, respectively.

A separator roll 10 can be carried from outside the third chamber 43 and placed into the rack 201, which is provided in the third chamber 43, with use of a robot arm 2031 corresponding to the third chamber 43. A separator roll 10 can be taken out of the rack 202, which is provided in the third chamber 43, and carried to outside the third chamber 43 with use of that robot arm 2031. Specifically, the robot arm 2031 corresponding to the third chamber 43 helps carrying a separator roll(s) 10 into and out of the third chamber 43 through an opening thereof that is formed as the third door 53 of the third chamber 43 is opened. The robot arm 2031 may carry out a separator roll(s) 10 out of the third chamber 43 and place the separator roll(s) 10 in a packaging device 600 present outside the third chamber 43. Packaging a separator roll(s) 10 immediately after inspection can prevent a new foreign object from adhering to the separator roll(s) 10. The robot arm 2031 may have a configuration identical to that of the robot arm 203.

Similarly, a separator roll 10 can be carried from outside the fourth chamber 44 and placed into the rack 201, which is provided in the fourth chamber 44, with use of a robot arm 2031 corresponding to the fourth chamber 44. A separator roll 10 can be taken out of the rack 202, which is provided in the fourth chamber 44, and carried to outside the fourth chamber 44 with use of that robot arm 2031. Specifically, the robot arm 2031 corresponding to the fourth chamber 44 helps carrying a separator roll(s) 10 into and out of the fourth chamber through an opening thereof that is formed as the fourth door 54 of the fourth chamber 44 is opened. The robot arm 2031 may carry out a separator roll(s) 10 out of the fourth chamber 44 and place the separator roll(s) in the packaging device 600 present outside the fourth chamber 44. Packaging a separator roll(s) 10 immediately after inspection can prevent a new foreign object from adhering to the separator roll(s) 10. The robot arm 2031 may have a configuration identical to that of the robot arm 203.

Each of the robot arms 2031 may be placed inside a corresponding one of the second chamber 42, the third chamber 43, and the fourth chamber 44. The robot arms 2031 may alternatively be placed outside the second chamber 42, the third chamber 43, and the fourth chamber 44. Furthermore, a single robot arm 2031 may correspond to some of the second chamber 42, the third chamber 43, and the fourth chamber 44. Moreover, the packaging device 600 may be one or more packaging devices 600.

Then, an operator 500 can carry out an operation in a space outside the inspection system 1E.

The inspection system 1E allows more separator rolls 10 to be inspected and more separator rolls 10 having been inspected to be stocked in the second chamber 42, the third chamber 43, and the fourth chamber 44. This achieves greater operation efficiency.

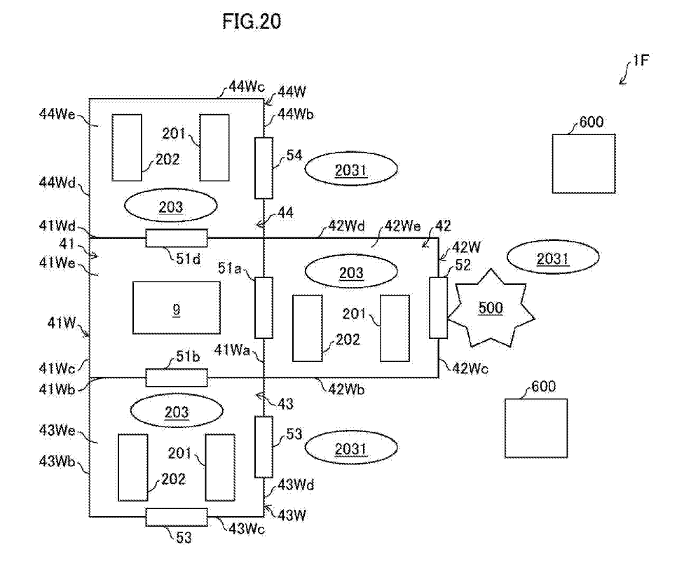

FIG. 20 is a planar diagram illustrating the configuration of an inspection system 1F in accordance with Variation 1 of Embodiment 7. The inspection system 1F is identical to the inspection system 1E (FIG. 19) except that the robot arm 203 is provided not in the first chamber 41 but in each of the second chamber 42, the third chamber 43, and the fourth chamber 44. The inspection system 1F is otherwise similar in configuration to the inspection system 1E.

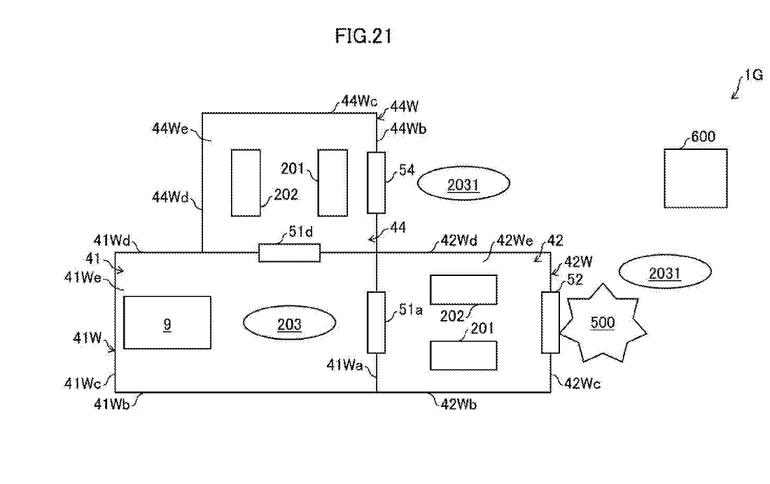

FIG. 21 is a planar diagram illustrating the configuration of an inspection system 1G in accordance with Variation 2 of Embodiment 7. The inspection system 1G is identical to the inspection system 1E (FIG. 19) except that the inspection system 1G does not include the third chamber 43. The inspection system 1G is otherwise similar in configuration to the inspection system 1E.

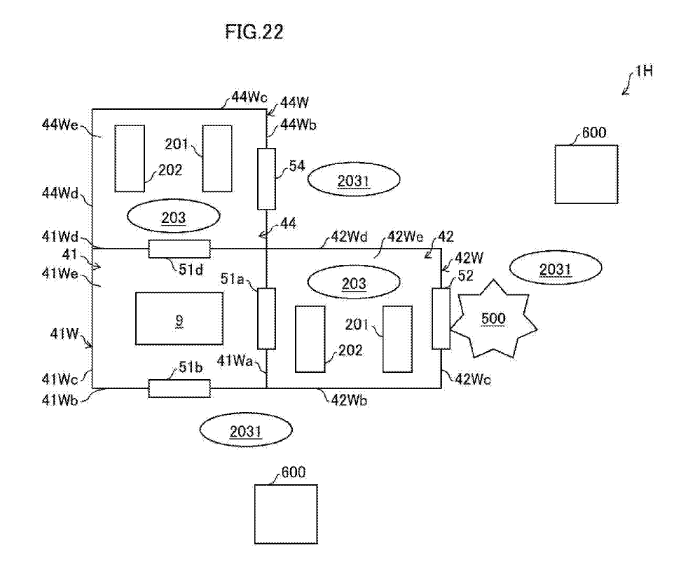

FIG. 22 is a planar diagram illustrating the configuration of an inspection system 1H in accordance with Variation 3 of Embodiment 7. The inspection system 1H is identical to the inspection system 1F (FIG. 20) except that the inspection system 1H does not include the third chamber 43. The inspection system 1H is otherwise similar in configuration to the inspection system 1F.

### Embodiment 8

The description below deals with Embodiment 8 of the present invention. Note that for convenience of explanation, identical reference numerals are given to members which have respective functions identical with those described in any of Embodiments 1 to 7, and descriptions of the respective members are not repeated here.

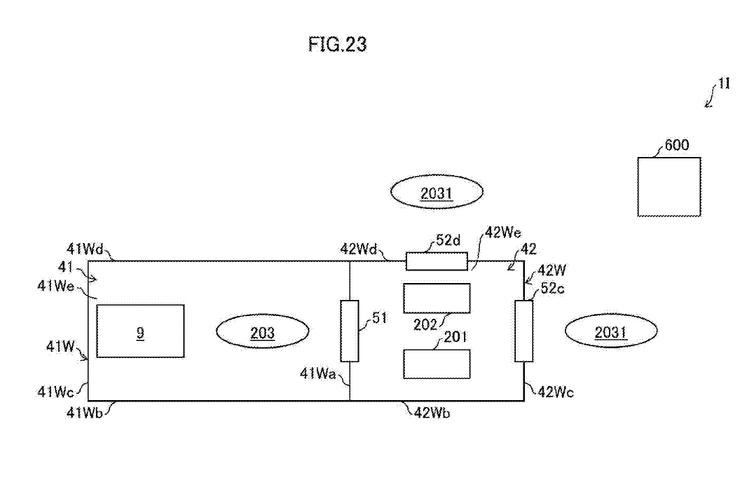

FIG. 23 is a planar diagram illustrating the configuration of an inspection system 1I in accordance with Embodiment 8. The inspection system 1I is configured to include second blocking sections 52c and 52d in place of the second blocking section 52 of the inspection system 1 (FIG. 18). Robot arms 2031 are provided so as to correspond to the respective second blocking sections 52c and 52d. The inspection system 1I is otherwise similar in configuration to the inspection system 1.

The second blocking section 52c is provided on a sidewall 42Wc, and the second blocking section 52d is provided on a sidewall 42d. The second blocking sections 52c and 52d separate a second chamber 42 and outside space from each other. The second blocking sections 52c and 52d block an electromagnetic wave that a radiation source section 2 provided in a first chamber 41 emits.

As described above, the inspection system 1I allows a separator roll(s) 10 to be carried into and out of the second chamber 42 through the second blocking sections 52c and 52d. This achieves greater operation efficiency. Note that a wall that separates the second chamber 42 and outside space from each other may be provided with not only two but also three or more second blocking sections. Furthermore, the third chamber 43 and the fourth chamber 44, which are illustrated in FIGS. 19 to 22, may each be provided with a plurality of doors that separate a corresponding one of the third chamber 43 and the fourth chamber 44 and outside space.

### Embodiment 9

The description below deals with Embodiment 9 of the present invention. Note that for convenience of explanation, identical reference numerals are given to members which have respective functions identical with those described in any of Embodiments 1 to 8, and descriptions of the respective members are not repeated here.

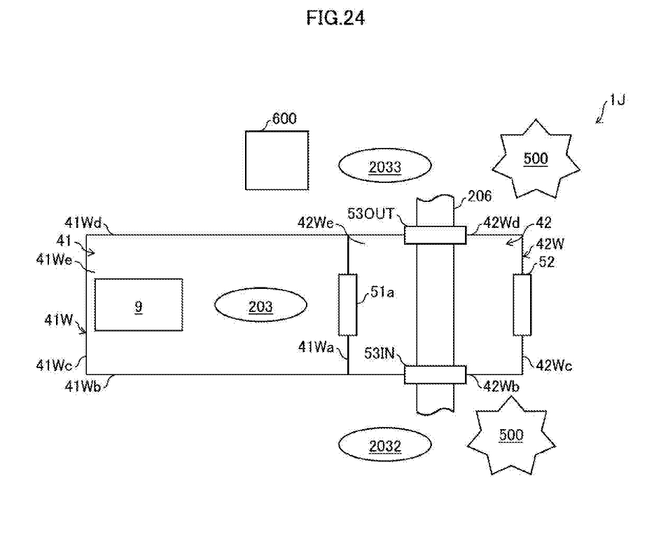

As illustrated in FIGS. 24 to 26, an inspection system provided with a belt conveyor may also be configured such that a robot arm is provided in a first chamber and/or a plurality of front chambers in each of which either a separator roll 10 to be inspected or a separator roll 10 having been inspected is stocked are provided.

FIG. 24 is a planar diagram illustrating the configuration of an inspection system 1J in accordance with Embodiment 9. The inspection system 1J is identical to the inspection system 1B (FIG. 15) except that the robot arm 203 is provided not in a second chamber 42 but in a first chamber 41. The inspection system 1J is otherwise similar in configuration to the inspection system 1B.

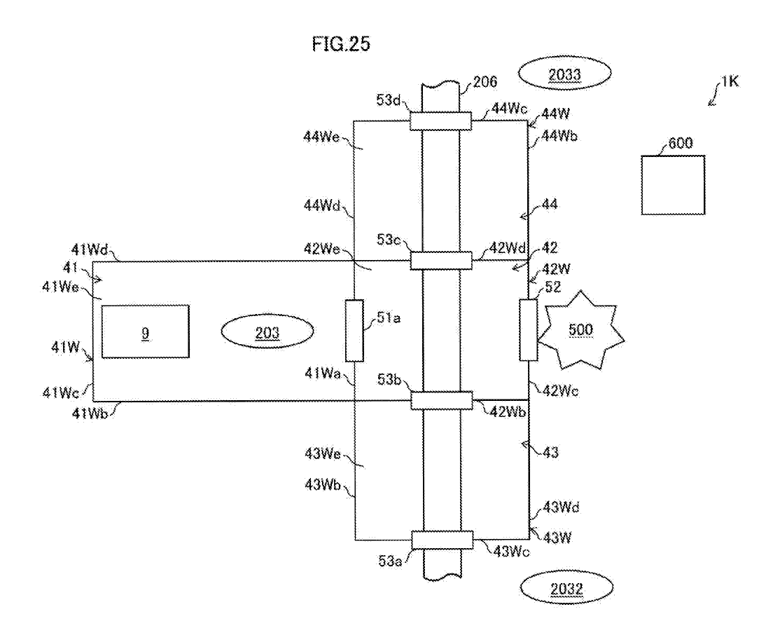

FIG. 25 is a planar diagram illustrating the configuration of an inspection system 1K in accordance with Variation 1 of Embodiment 9. The inspection system 1K is configured to include a third chamber 43 in place of the second blocking section 52IN of the inspection system 1B (FIG. 15) and further include a fourth chamber 44 in place of the second blocking section 52OUT of the inspection system 1B. The third chamber 43 includes blocking sections 53a and 53b, and the fourth chamber 44 includes blocking sections 53c and 53d. Robot arms 2032 and 2033 are provided outside the third chamber 43 and the fourth chamber 44, respectively. The inspection system 1K is otherwise similar in configuration to the inspection system 1J.

According to the inspection system 1K, the second chamber 42, the third chamber 43, and the fourth chamber 44 are arranged in a direction in which a belt conveyor 206 extends, and the belt conveyor 206 passes through the second chamber 42, the third chamber 43, and the fourth chamber 44.

In the example of FIG. 25, the third chamber 43 is next to one side of the second chamber 42, and the fourth chamber 44 is next to the other side of the second chamber 42.

A wall by which the second chamber 42 is surrounded includes (i) a sidewall 42Wb which separates the second chamber 42 and the third chamber from each other and (ii) a sidewall 42Wd which separates the second chamber 42 and the fourth chamber 44 from each other.

The blocking section 53a is provided on a sidewall 43Wc, the blocking section 53b is provided on the sidewall 42Wb, the blocking section 53c is provided on the sidewall 42Wd, and the blocking section 53d is provided on a sidewall 44Wc.

The blocking sections 53a to 53d can each be structured to, while allowing the belt conveyor 206 and a separator roll 10 which is placed on the belt conveyor 206 to pass therethrough, make it possible to prevent an electromagnetic wave that a radiation source section 2 emits from leaking outside the second chamber 42.

For example, the blocking sections 53a to 53d can each be structured to have a wall which is provided with a through hole which is covered with a curtain. In a case where the electromagnetic wave that the radiation source section 2 emits is X rays, the curtain preferably contains lead. A structure with which to cover the through hole may be a door (e.g., a horizontally sliding door or a vertically sliding door) or may be a door which is provided with a curtain which prevents an electromagnetic wave from leaking through a gap in the door.

The belt conveyor 206 passes through the third chamber 43, the second chamber 42, and the fourth chamber 44 by passing through the blocking sections 53a to 53d in this order.

The inspection system 1K, which includes the third chamber 43 and the fourth chamber 44, (i) makes it possible to more sufficiently prevent an electromagnetic wave from leaking and (ii) makes it easy to maintain cleanliness of an environment of the second chamber 42 at a high level. Furthermore, in the third chamber 43 and the fourth chamber 44, it is possible to carry out other operation(s) (e.g., to label a separator roll(s) 10 and/or to check appearance of a separator roll(s) 10).

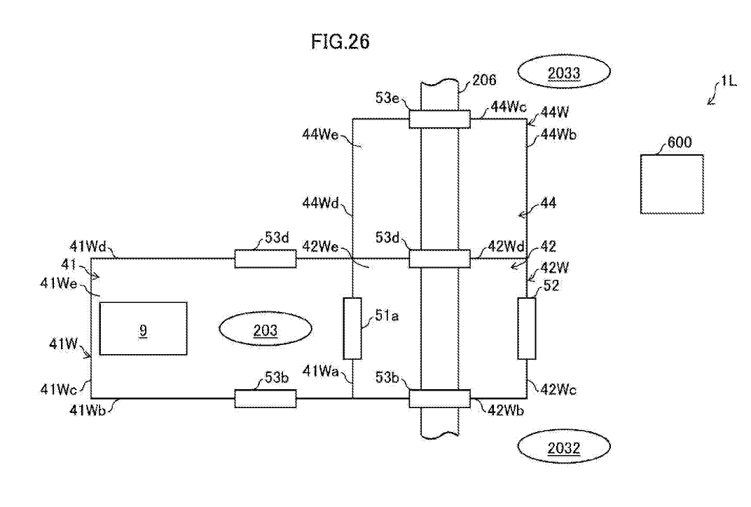

FIG. 26 is a planar diagram illustrating the configuration of an inspection system 1L in accordance with Variation 2 of Embodiment 9. The inspection system 1L is identical to the inspection system 1K (FIG. 25) except that the inspection system 1L does not include the third chamber 43.

### Embodiment 10

The description below deals with Embodiment 10 of the present invention. Note that for convenience of explanation, identical reference numerals are given to members which have respective functions identical with those described in any of Embodiments 1 to 9, and descriptions of the respective members are not repeated here.

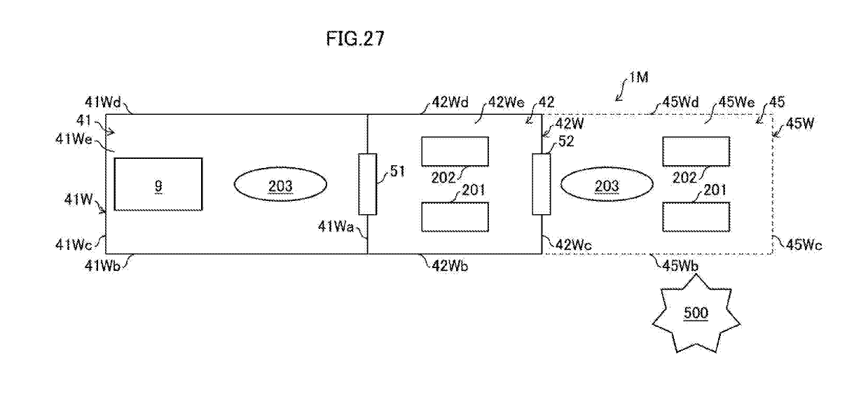

FIG. 27 is a planar diagram schematically illustrating the configuration of an inspection system 1M in accordance with Embodiment 10.

The inspection system 1M is identical to the inspection system 1 (FIG. 18) except that a fifth chamber 45 is provided next to the second chamber 42 and the fifth chamber 45 is also provided with a robot arm 203 and racks 201 and 202. The inspection system 1M is otherwise similar in configuration to the inspection system 1.

In the example of FIG. 27, the fifth chamber 45 is adjacent to the second chamber 42 and is not adjacent to the first chamber 41. The fifth chamber 45 is surrounded by a sidewall 42Wc and a wall 45W. The wall 45W includes sidewalls 45Wb to 45Wd, a floor 45We, and a ceiling (not illustrated). The sidewalls 45Wb to 45Wd stand on the floor 45We. The sidewalls 42Wc and 45Wc face each other. The sidewalls 45Wb and 45Wd face each other. The ceiling is supported by the sidewalls 42Wc and 45Wb to 45Wd and faces the floor 45We.

The sidewall 42Wc is shared by the second chamber 42 and the fifth chamber 45 and separates the second chamber 42 and the fifth chamber 45 from each other.

The fifth chamber 45 is a room in which an operator 500 carries out an operation. The sidewalls 45Wb to 45Wd by which the fifth chamber 45 is surrounded, the floor 45We, and the ceiling do not need to block an electromagnetic wave that a radiation source section 2 emits. The configuration is, however, not limited to the above. The ceiling facing the floor 45We may not be supported by one or more of the sidewalls 42Wc and 45Wb to 45Wd, or may be supported by none of the sidewalls 42Wc and 45Wb to 45Wd. Further, the ceiling facing the floor 45We may even be absent.

The fifth chamber 45 is also provided with the robot arm 203 and the racks 201 and 202.

Note that the sidewalls 45Wb to 45Wd by which the fifth chamber 45 is surrounded may each be, for example, a fence instead of a wall.

### Embodiment 11

The description below deals with Embodiment 11 of the present invention. Note that for convenience of explanation, identical reference numerals are given to members which have respective functions identical with those described in any of Embodiments 1 to 10, and descriptions of the respective members are not repeated here.

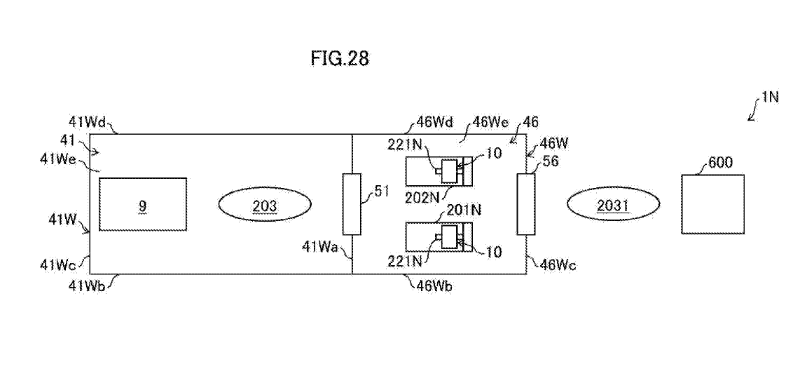

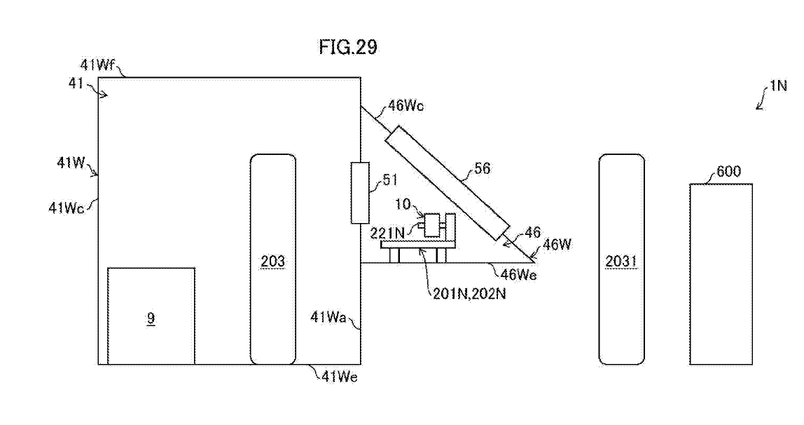

FIG. 28 is a planar diagram schematically illustrating the configuration of an inspection system 1N in accordance with Embodiment 11. FIG. 29 is a cross-sectional view schematically illustrating the configuration of the inspection system 1N in accordance with Embodiment 11.

As illustrated in FIGS. 28 and 29, the inspection system 1N is identical to the inspection system 1 (FIG. 18) except that the inspection system 1N includes a second chamber 46 and racks 201N and 202N in place of the second chamber 42 and the racks 201 and 202. The inspection system 1N is otherwise similar in configuration to the inspection system 1 (FIG. 18).

The second chamber 46 is surrounded by (i) a wall 46W that blocks an electromagnetic wave that a radiation source section 2 provided in a first chamber emits and (ii) a sidewall 41Wa. The wall 46W includes sidewalls 46Wb to 46Wd and a floor 46We. The sidewalls 46Wb to 46Wd stand on the floor 46We. The sidewalls 41Wa and 46Wc face each other. The sidewalls 46Wb and 46Wd face each other. The sidewalls 46Wb and 46Wd are each triangular. The floor 46We is higher than a floor 41We of the first chamber 41.

The sidewall 46Wc is inclined to the floor 46We, the base of the sidewall 46Wc is in contact with the floor 46We, and an upper side, opposite to the base, of the sidewall 46Wc is in contact with a sidewall 41a. This causes the sidewall 46Wc to serve also as a ceiling.

The sidewall 46Wc is provided with a second blocking section 56. The second blocking section 56 separates the second chamber 46 and outside space from each other. Since the sidewall 46Wc is inclined, the second blocking section 56 is also inclined.

The racks 201N and 202N, which are provided on the floor 46We of the second chamber 46, are each a stocking mechanism for stocking a separator roll(s) 10.

The racks 201N and 202N each include one or more holding members 221N each configured to hold one or more separator rolls 10. The holding members 221N are, for example, each a bar-shaped member on which a separator roll(s) 10 is/are fitted in a state where a holding member 221 extends from a side of a second side surface 10c of the separator roll(s) 10 through a first through hole 8a of a core 8. This allows a robot arm 203 to place the separator roll(s) 10 in the racks 201N and 202N and take the separator roll(s) thus placed out of the racks 201N and 202N.

As described above, according to the inspection system 1N, the floor 46We of the second chamber 46, which is a front chamber, is higher than the floor 41We of the first chamber 41, and the sidewall 46Wc and the second blocking section 56 incline. This makes it easier for an operator who is present in a space outside the second chamber 46 to (i) place, in the rack 201N, a separator roll 10 which has not been inspected and (ii) take out a separator roll 10 which has been inspected and is placed in the rack 202N. This allows an operator to carry out an operation with greater efficiency.

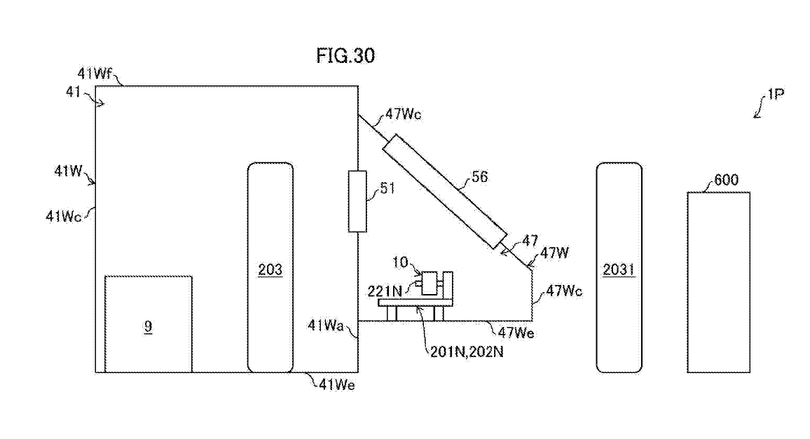

FIG. 30 is a cross-sectional view schematically illustrating the configuration of an inspection system 1P in accordance with a variation of Embodiment 11. The inspection system 1P is similar in planar shape to the inspection system 1N illustrated in FIG. 28.

The inspection system 1P includes a second chamber 47 in place of the second chamber 46 of the inspection system 1N. The second chamber 47 is provided with racks 201N and 202N.

The second chamber 47 is surrounded by (i) a wall 47W that blocks an electromagnetic wave that a radiation source section 2 provided in a first chamber 41 emits and (ii) a sidewall 41Wa. The wall 47W includes sidewalls 47Wb to 47Wd and a floor 47We. The sidewalls 47Wb to 47Wd stand on the floor 47We. The sidewalls 41Wa and 47Wc face each other. The sidewalls 47Wb and 47Wd face each other. The sidewalls 47Wb and 47Wd are each a quadrangle whose upper side is inclined. The floor 47We is higher than a floor 41We of the first chamber 41.

The sidewall 47Wc stands at right angles to the floor 47We and bends toward the first chamber 41 at a bend located between (a) the base of the sidewall 47Wc and (b) an upper side of the sidewall 47Wc, and the upper side, opposite to the base, of the sidewall 47Wc is in contact with a sidewall 41a. This causes the sidewall 47Wc to serve also as a ceiling. The sidewall 47Wc is provided with a second blocking section 56. The second blocking section 56 is provided in an inclined region of the sidewall 47Wc and is also inclined.

The inspection system 1P illustrated in FIG. 30 also makes it easier for an operator who is present in a space outside the second chamber 47 to (i) place, in the rack 201N, a separator roll 10 which has not been inspected and (ii) take out a separator roll 10 which has been inspected and is placed in the rack 202N. This allows an operator to carry out an operation with greater efficiency.

### Embodiment 12

The description below deals with Embodiment 12 of the present invention. Note that for convenience of explanation, identical reference numerals are given to members which have respective functions identical with those described in any of Embodiments 1 to 11, and descriptions of the respective members are not repeated here.

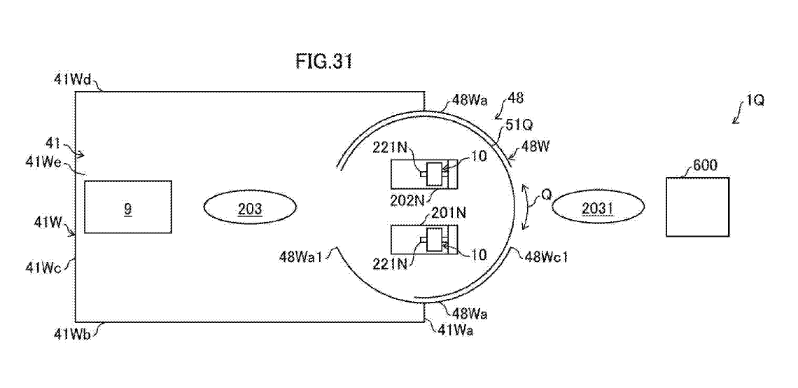

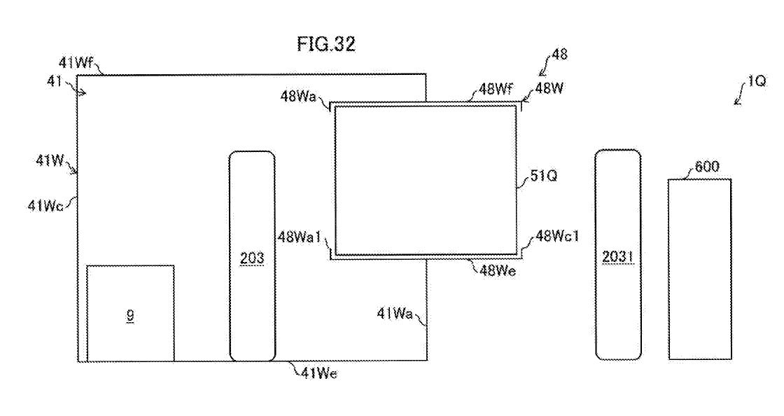

FIG. 31 is a planar diagram schematically illustrating the configuration of an inspection system 1Q in accordance with Embodiment 12. FIG. 32 is a cross-sectional view schematically illustrating the configuration of the inspection system 1Q in accordance with Embodiment 12.

As illustrated in FIGS. 31 and 32, the inspection system 1Q is identical to the inspection system 1N (FIG. 28) except that the inspection system 1Q includes a second chamber 48 in place of the first blocking section 51 and the second chamber 46. A robot arm 2031 may be placed outside or inside the second chamber 48. The inspection system 1Q is otherwise similar in configuration to the inspection system 1N (FIG. 28).

The second chamber 48 may be a so-called pass box through which separator rolls 10 pass between a first chamber 41 and a space outside the first chamber 41 and the second chamber 48.

The second chamber 48 is provided on a wall 41Wa. The second chamber 48 is surrounded by (i) a wall 48W that blocks an electromagnetic wave that a radiation source section 2 provided in the first chamber 41 emits. The wall 48W includes a sidewall 48Wa, a floor (stocking mechanism) 48We, and a ceiling 48Wf. The sidewall 48Wa has a substantially cylindrical shape and stands on the floor 48We. The ceiling 48Wf is supported by the sidewall 48Wa and faces the floor 48We.

The sidewall 48Wa is provided with an opening 48Wa1 and an opening 48Wc1, which face each other. Through the openings 48Wa1 and 48Wc1, separator rolls 10 can pass between the first chamber 41 and the space outside the first chamber 41 and the second chamber 48.

It is possible to directly place, on the floor 48We, a separator roll 10 which is stocked in the second chamber 48 so as to be carried from the second chamber 48 to the first chamber 41, or a separator roll 10 which is carried out of the first chamber 41 into the second chamber 48 so as to be stocked in the second chamber 48. Alternatively, for example, racks 201N and 202N (e.g., FIGS. 28 and 29) may be provided on the floor 48We.

The second chamber 48 further includes a first blocking section 51Q which is surrounded by the wall 48W.

The first blocking section 51Q is a door configured to allow the first chamber 41 and the second chamber to communicate with each other, the door being capable of being opened and closed.

The first blocking section 51Q includes a material that blocks an electromagnetic wave that the radiation source section 2 emits. The first blocking section 51Q curves around an imaginary rotation axis, which extends in a direction normal to the floor 48We, so as to be rotatable on the rotation axis. Both sides of the first blocking section 51Q thus curving are apart from each other. The both sides which are apart from each other are sides of the first blocking section 51Q which sides each extend in the direction normal to the floor 48We.

As indicated by an arrow Q of FIG. 31, in a case where the first blocking section 51Q rotates on the imaginary rotation axis, which extends in the direction normal to the floor 48We, and a region between the both sides of the first blocking section 51Q, which both sides are apart from each other, overlaps the opening 48Wa1, the first chamber 41 and the second chamber 48 communicate with each other (are in an open state), and the second chamber 48 and the space outside the first chamber 41 and the second chamber 48 are blocked from each other (are in a closed state). This allows separator rolls 10 to pass between the first chamber 41 and the second chamber 48.

As indicated by the arrow Q (FIG. 31), in a case where the first blocking section 51Q rotates, and the region between the both sides of the first blocking section 51Q, which both sides are apart from each other, overlaps the opening 48Wc1, the first chamber 41 and the second chamber 48 are blocked from each other (are in the closed state), and the second chamber 48 and the space outside the first chamber 41 and the second chamber 48 are in the open state. This allows separator rolls 10 to pass between the second chamber 48 and the space outside the first chamber 41 and the second chamber 48.

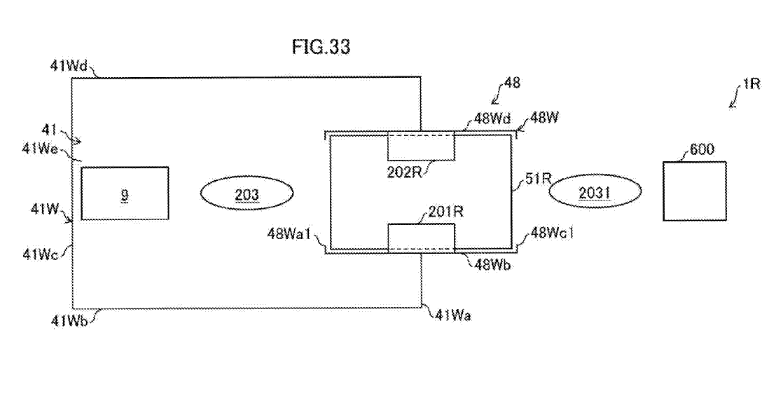

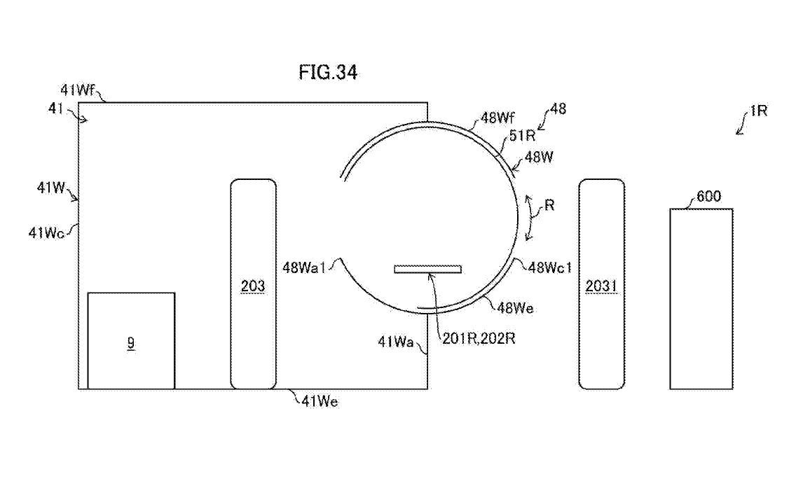

The first blocking section 51Q illustrated in each of FIGS. 31 and 32 may alternatively be a first blocking section 51R which is illustrated in each of FIGS. 33 and 34 and is different in rotation direction from the first blocking section 51Q.

FIG. 33 is a planar diagram schematically illustrating the configuration of an inspection system 1R in accordance with Variation 1 of Embodiment 12. FIG. 34 is a cross-sectional view schematically illustrating the configuration of the inspection system 1R in accordance with Variation 1 of Embodiment 12.

The inspection system 1R is identical to the inspection system 1Q except that the inspection system 1R includes a first blocking section 51R in place of the first blocking section 51Q and further includes racks 201R and 202R. The inspection system 1R is otherwise similar in configuration to the inspection system 1Q.

The racks 201R and 202R are provided not on a floor 48We of a second chamber 48 but above the floor 48We. For example, the racks 201R and 202R are provided at a portion of the sidewall 48Wa which portion is between the opening 48Wa1 and the opening 48Wc1 so as to face each other and extend in a direction normal to a straight line connecting the opening 48Wa1 and the opening 48Wc1.

The first blocking section 51R is a door configured to allow a first chamber 41 and the second chamber 48 to communicate with each other, the door being capable of being opened and closed.

The first blocking section 51R includes a material that blocks an electromagnetic wave that a radiation source section 2 emits. The first blocking section 51R curves around an imaginary rotation axis, which extends in a direction normal to the straight line connecting the opening 48Wa1 and the opening 48Wc1 (a direction parallel to the floor 48We), so as to be rotatable on the rotation axis. Both sides of the first blocking section 51R thus curving are apart from each other. The both sides which are apart from each other are sides of the first blocking section 51R which sides each extend in the direction parallel to the floor 48We.

As indicated by an arrow R of FIG. 34, in a case where the first blocking section 51R rotates on the imaginary rotation axis, which extends in the direction parallel to the floor 48We, and a region between the both sides of the first blocking section 51R, which both sides are apart from each other, overlaps an opening 48Wa1, the first chamber 41 and the second chamber 48 communicate with each other (are in an open state), whereas the second chamber 48 and a space outside the first chamber 41 and the second chamber 48 are blocked from each other (are in a closed state). This allows separator rolls 10 to pass between the first chamber 41 and the second chamber 48.

As indicated by the arrow R (FIG. 34), in a case where the first blocking section 51R rotates, and the region between the both sides of the first blocking section 51R, which both sides are apart from each other, overlaps the opening 48Wc1, the first chamber 41 and the second chamber 48 are blocked from each other (are in the closed state), whereas the second chamber 48 and the space outside the first chamber 41 and the second chamber 48 are in the open state. This allows separator rolls 10 to pass between the second chamber 48 and the space outside the first chamber 41 and the second chamber 48.

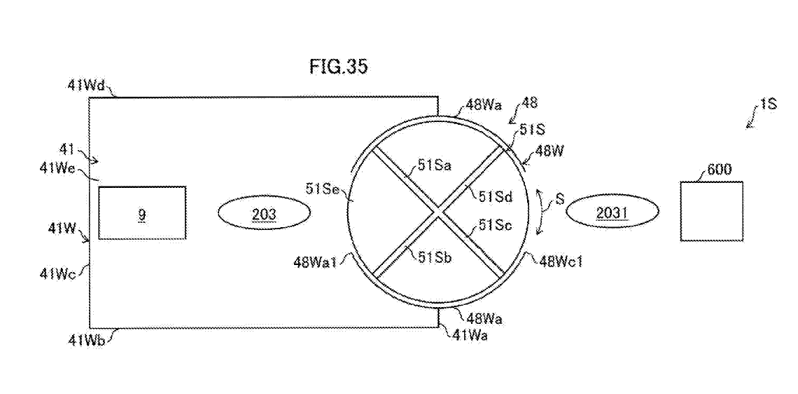

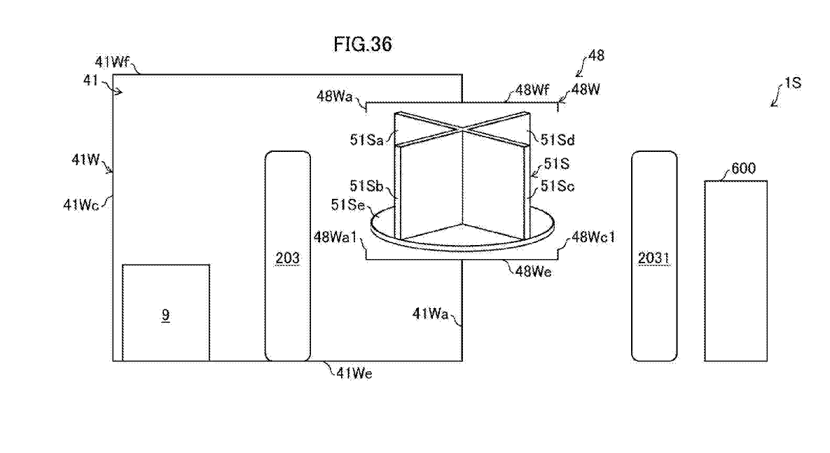

The first blocking section 51R may alternatively be a rotary table which is partitioned crosswise, such as a first blocking section 51S illustrated in each of FIGS. 35 and 36.

FIG. 35 is a planar diagram schematically illustrating the configuration of an inspection system 1S in accordance with Variation 2 of Embodiment 12. FIG. 36 is a cross-sectional view schematically illustrating the configuration of the inspection system 15 in accordance with Variation 2 of Embodiment 12. Note that for description of the first blocking section 51S, only the first blocking section 51S is illustrated by a perspective view in FIG. 36.

The inspection system 15 is identical to the inspection system 1Q (FIGS. 31 and 32) except that the inspection system 15 includes a first blocking section 51S in place of the first blocking section 51Q. The inspection system 15 is otherwise similar in configuration to the inspection system 1Q.

The first blocking section 51S is a door configured to allow a first chamber 41 and a second chamber 48 to communicate with each other, the door being capable of being opened and closed.

The first blocking section 51S includes a material that blocks an electromagnetic wave that a radiation source section 2 emits. The first blocking section 51S includes partition plates 51Sa to 51Sd and a bottom plate (stocking mechanism) 51Se. The bottom plate 51Se is provided so as to face the floor 48We. The partition plates 51Sa to 51Sd stand on the bottom plate 51Se. The partition plates 51Sa to 51Sd each have two sides extending in a direction normal to the bottom plate 51Se, and are connected with each other with one of the two sides.

The partition plates 51Sa to 51Sd are provided so that cross sections thereof (illustrated in FIG. 35) taken along a direction parallel to the bottom plate 51Se are cross-shaped. The partition plates 51Sa to 51Sd thus provided divide the bottom plate 51Se into four regions.

In the examples shown in FIGS. 35 and 36, the partition plates 51Sa to 51Sd are provided so as to be arranged in a counterclockwise order.

It is possible to directly place, on the bottom plate 51Se, a separator roll 10 which is stocked in the second chamber 48 so as to be carried from the second chamber 48 to the first chamber 41, or a separator roll 10 which is carried out of the first chamber 41 into the second chamber 48 so as to be stocked in the second chamber 48. Alternatively, for example, racks 201N and 202N (e.g., FIGS. 28 and 29) may be provided on the bottom plate 51Se.

The first blocking section 51S rotates on the side with which each of the partition plates 51Sa to 51Sd is in contact, the side serving as a rotation axis.

In a case where one of four rooms into which the second chamber 48 is partitioned by the first blocking section 51S and an opening 48Wa1 overlap each other to an extent that allows a separator roll 10 to be put in or taken out through the opening 48Wa1, the first chamber 41 and the above one of the four rooms of the second chamber 48 communicate with each other.

This allows separator rolls 10 to pass between the first chamber 41 and the second chamber 48.

In contrast, in a case where the above one of the four rooms partitioned by the first blocking section 51S overlaps the opening 48Wa1 to an extent that allows a separator roll 10 to be put in or taken out through the opening 48Wa1, the other rooms of the four rooms partitioned by the first blocking section 51S are blocked from the first chamber 41.

In a case where one of the four rooms into which the second chamber 48 is partitioned by the first blocking section 51S and an opening 48Wc1 overlap each other to an extent that allows a separator roll 10 to be put in or taken out through the opening 48Wc1, the above one of the four rooms of the second chamber 48 and a space outside the first chamber 41 and the second chamber 48 communicate with each other.

This allows separator rolls 10 to pass between the second chamber 48 and the space outside the first chamber 41 and the second chamber 48.

In contrast, in a case where the above one of the four rooms partitioned by the first blocking section 51S overlaps the opening 48Wc1 to an extent that allows a separator roll 10 to be carried in or out, the other rooms of the four rooms partitioned by the first blocking section 51S are blocked from the space outside the first chamber 41 and the second chamber 48.

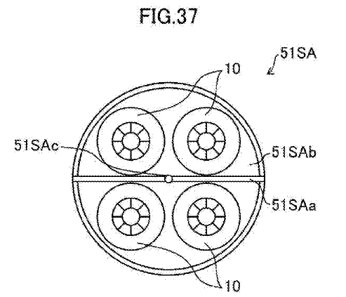

FIG. 37 is a planar diagram showing an example of the configuration of a first blocking section which is divided into two. The first blocking section 51S illustrated in each of FIGS. 35 and 36 may be, as in a first blocking section SA illustrated in FIG. 37, a first blocking section obtained by dividing the second chamber 48 into two.

The first blocking section 51SA is a door configured to allow the first chamber 41 and the second chamber 48 to communicate with each other, the door being capable of being opened and closed.

The first blocking section 51SA includes a material that blocks an electromagnetic wave that the radiation source section 2 emits. The first blocking section 51SA includes a partition plate 51SAa and a bottom plate (stocking mechanism) 51SAb. The bottom plate 51SAb is provided so as to face the floor 48We (FIGS. 35 and 36). The partition plate 51SAa stands on the bottom plate 51SAb and divides the bottom plate 51SAb into two regions.

It is possible to directly place, on the bottom plate 51SAb, a separator roll 10 which is stocked in the second chamber 48 so as to be carried from the second chamber 48 (FIGS. 35 and 36) to the first chamber 41, or a separator roll 10 which is carried out of the first chamber 41 into the second chamber 48 so as to be stocked in the second chamber 48. Alternatively, for example, the racks 201N and 202N (e.g., FIGS. 28 and 29) may be provided on the bottom plate 51SAb.

The first blocking section 51SA rotates on a rotation axis 51SAc that extends from a center of the bottom plate 51SAb in a direction normal to the bottom plate 51SAb.

In a case where one of two rooms into which the second chamber 48 is partitioned by the first blocking section 51SA and the opening 48Wa1 (FIGS. 35 and 36) overlap each other to an extent that allows a separator roll 10 to be put in or taken out through the opening 48Wa1, the first chamber 41 and the above one of the two rooms of the second chamber 48 communicate with each other. Further, since the above one of the two rooms of the second chamber 48 is blocked from the space outside the first chamber 41 and the second chamber 48, the first chamber 41 and the space outside the first chamber 41 and the second chamber 48 are blocked from each other.

This allows separator rolls 10 to pass between the first chamber 41 and the second chamber 48.

In this state, the other one of the two rooms into which the second chamber 48 is partitioned by the first blocking section 51SA overlaps an opening 48Wc1 to an extent that allows a separator roll 10 to be put in or taken out through the opening 48Wc1. In other words, the other one of the two room of the second chamber 48 and a space outside the first chamber 41 and the second chamber 48 communicate with each other.

This allows separator rolls 10 to pass between the second chamber 48 and the space outside the first chamber 41 and the second chamber 48.

Note that the first blocking section 51SA may be provided in the second chamber 46 (FIGS. 28 and 29) of the inspection system 1N or in the second chamber 47 (FIG. 30) of the inspection system 1P.

### Embodiment 13

The description below deals with Embodiment 13 of the present invention. Note that for convenience of explanation, identical reference numerals are given to members which have respective functions identical with those described in any of Embodiments 1 to 12, and descriptions of the respective members are not repeated here.

FIG. 38 is a planar diagram schematically illustrating the configuration of an inspection system 1T in accordance with Embodiment 13.

As illustrated in FIG. 38, the inspection system 1T is identical to the inspection system 1 (FIG. 18) except that the inspection system 1T includes a second chamber 49 and a third chamber 143 in place of the second chamber 42. A robot arm 2031 may be placed outside or inside the third chamber 143. The inspection system 1T is otherwise similar in configuration to the inspection system 1 (FIG. 18).

The third chamber 143 is provided between a first chamber 41 and the second chamber 49 and configured to allow the first chamber 41 and the second chamber 49 to communicate with each other. The first chamber and the second chamber 49 are apart from each other and may be provided while a space (e.g., the third chamber 143) different from each of the first chamber 41 and the second chamber 49 is provided therebetween.

The second chamber 49 is surrounded by (i) a wall 49W that blocks an electromagnetic wave that a radiation source section 2 provided in the first chamber emits. The wall 49W includes sidewalls 49Wa to 49Wd, a floor 49We, and a ceiling (not illustrated). The sidewalls 49Wa to 49Wd stand on the floor 49We. The sidewalls 49Wa and 49Wc face each other. The sidewalls 49Wb and 49Wd face each other. The ceiling (not illustrated) is provided so as to face the floor 49We.

The sidewall 49Wa is provided with an a second blocking section 52a that can be opened and closed, and the sidewall 49Wc is provided with a second blocking section 52b that can be opened and closed.

The second blocking section 52a separates the second chamber 49 and the third chamber 143 from each other. The second blocking section 52b separates the second chamber 49 and outside space from each other. The second chamber 49 is provided with racks 201 and 202.

The third chamber 143 is surrounded by sidewalls 41Wa and 49Wa and a wall 143W. The wall 143W connects the first chamber 41 and the second chamber 49. The wall 143W may block an electromagnetic wave that the radiation source section 2 provided in the first chamber 41 emits. Alternatively, the wall 143W does not need to block the electromagnetic wave. The wall 143W includes sidewalls 143Wb and 143Wd, a floor 143We, and a ceiling (not illustrated). The sidewalls 143Wb and 143Wd stand on the floor 143We. The sidewalls 143Wb and 143Wd face each other. The ceiling (not illustrated) faces the floor 143We.

As in the inspection system 1T, the first chamber 41 and the second chamber 49 may be provided while a space such as a room (e.g., the third chamber 143), which is different from each of the first chamber 41 and the second chamber 49, or a corridor is provided therebetween.

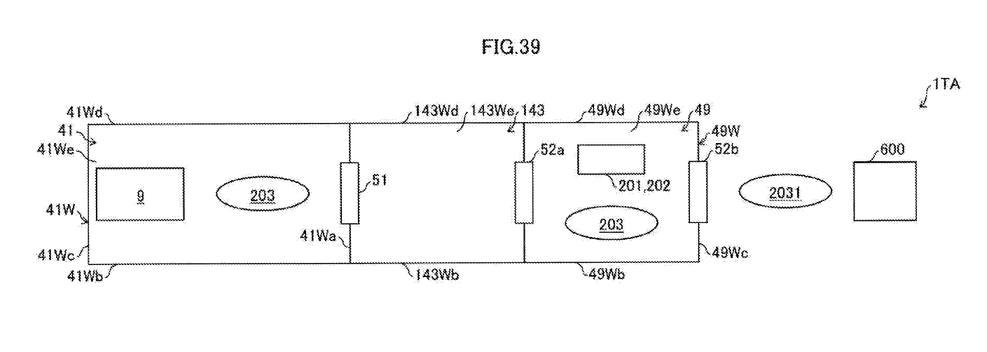

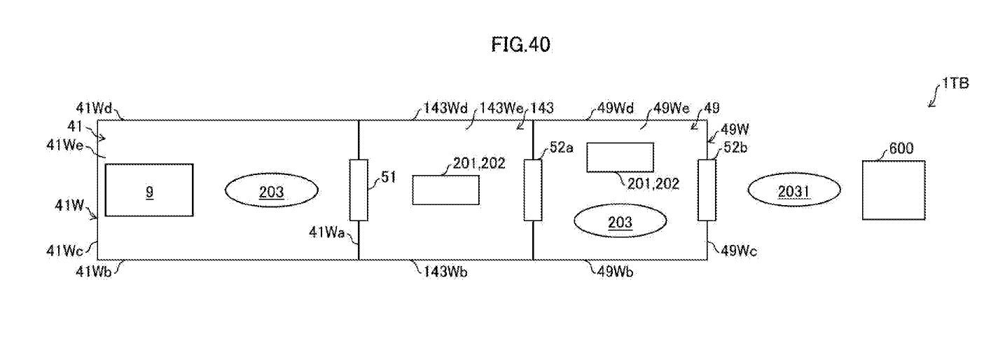

FIG. 39 is a planar diagram illustrating the configuration of an inspection system 1TA in accordance with Variation 1 of Embodiment 13. FIG. 40 is a planar diagram illustrating the configuration of an inspection system 1TB in accordance with Variation 2 of Embodiment 13.

As in the inspection system 1TA illustrated in FIG. 39, a robot arm 203 may be present in a second chamber 49. As in the inspection system 1TB illustrated in FIG. 40, racks 201 and 202 may be present in a third chamber 143.

[Recap]

An inspection system in accordance with an embodiment of the present invention includes: a radiation source section configured to emit an electromagnetic wave capable of passing through an inspection target; a sensor section configured to detect the electromagnetic wave, which the radiation source section has emitted and which has passed through the inspection target; a stocking mechanism configured to stock the inspection target; a first chamber surrounded by a first wall that blocks the electromagnetic wave; a second chamber surrounded by a second wall that blocks the electromagnetic wave; and a first blocking section configured to allow the first chamber and the second chamber to communicate with each other, the first blocking section being capable of being opened and closed, the radiation source section and the sensor section being present in the first chamber, the stocking mechanism being present in the second chamber.

The above configuration makes it possible to inspect an inspection target for a defect therein, as the sensor section detects an electromagnetic wave that the radiation source section has emitted and that has passed through the inspection target.

With the above configuration, (i) the radiation source section and the sensor section are present in the first chamber, (ii) the stocking mechanism is present in the second chamber, and (iii) the respective walls of the first chamber and the second chamber each block the electromagnetic wave.

This prevents an electromagnetic wave that the radiation source section has emitted from leaking to outside the first chamber and the second chamber. This can reduce influence which an electromagnetic wave that the radiation source section has emitted causes on the surroundings of the first chamber and the second chamber. Further, the above configuration can reduce influence which light external to the first chamber and the second chamber causes on the radiation source section and the sensor section.

With the above configuration, the wall separating the first chamber and the second chamber from each other is provided with a first blocking section. Closing the first blocking section can, in a case where an electromagnetic wave emitted by the radiation source section has been reflected by, for example, a wall, prevent such an electromagnetic wave from reaching an inspection target stocked in the second chamber. This can prevent quality degradation caused by the electromagnetic wave to the stocked inspection target.

The first chamber and the second chamber each block the electromagnetic wave. Thus, opening the first blocking section allows an inspection target in the second chamber to be carried out into the first chamber and an inspection target having been inspected in the first chamber to be carried out into the second chamber without stopping the emission of the electromagnetic wave by the radiation source section. This configuration makes it possible to continue inspection of an inspection target efficiently.

An inspection system in accordance with an embodiment of the present invention may be arranged such that the second wall is provided with, at a position other than a position of a wall separating the first chamber and the second chamber from each other, a second blocking section capable of being opened and closed, and the first blocking section and the second blocking section each include a material that blocks the electromagnetic wave.

With the above configuration, closing the first blocking section allows, while the inspection device continues to inspect an inspection target for a defect therein in the first chamber, an inspection target to be carried into the second chamber and an inspection target to be carried out of the second chamber through the second blocking section. This makes it possible to inspect an inspection target efficiently.

The above configuration eliminates the need to turn on and off the radiation source section in the first chamber each time an inspection target is carried into the second chamber or an inspection target is carried out of the second chamber. This saves the time period necessary to turn the radiation source section 2 on and off, and also prevents degradation caused to the radiation source section by frequently turning the radiation source section on and off.

An inspection system in accordance with an embodiment of the present invention may further include a conveying mechanism configured to (i) hold the inspection target stocked on the stocking mechanism and carry the inspection target from the second chamber to the first chamber through the first blocking section and (ii) carry the inspection target from the first chamber to the second chamber through the first blocking section.

With the above configuration, closing the second blocking section allows an inspection target to be inspected to be carried by the conveying mechanism out of the second chamber into the first chamber and an inspection target having been inspected to be carried by the conveying mechanism out of the first chamber into the second chamber without stopping the emission of an electromagnetic wave by the radiation source section. This makes it possible to inspect an inspection target efficiently.

An inspection system in accordance with an embodiment of the present invention may be arranged such that the first blocking section is positioned so as not to be irradiated directly with the electromagnetic wave, which the radiation source section has emitted.

The above configuration can, even in a case where the first blocking section and the second blocking section have both been opened for a reason while the radiation source section is emitting the electromagnetic wave, reduce the amount of electromagnetic wave that the radiation source section is emitting and that leaks to outside the first chamber and the second chamber.

Further, the above configuration can, even in a case where the first blocking section has been opened while the radiation source section is emitting the electromagnetic wave, reduce the amount of electromagnetic wave to which an inspection target in the second chamber is exposed.

An inspection system in accordance with an embodiment of the present invention may be arranged such that the first blocking section and the second blocking section are non-parallel to each other.

The above configuration can, in a case where the first blocking section and the second blocking section have both been opened for a reason during inspection in the first chamber, reduce the amount of electromagnetic wave that the radiation source section is emitting and that leaks to outside the second chamber.

An inspection system in accordance with an embodiment of the present invention may be arranged such that the stocking mechanism is a rack including a holding member configured to hold the inspection target.

With the above configuration, carrying the stocking mechanism into and out of the second chamber allows an inspection target to be inspected to be easily carried into the second chamber and an inspection target having been inspected to be easily carried out of the second chamber.

An inspection system in accordance with an embodiment of the present invention may be arranged such that the stocking mechanism is a conveyor either extending from outside the second chamber into the second chamber or extending through the second chamber. This configuration allows an inspection target to be easily carried into and out of the second chamber.

An inspection system in accordance with an embodiment of the present invention may be arranged such that the electromagnetic wave is an X ray. This configuration makes it possible to inspect a non-transparent object as an inspection target for a defect therein.

An inspection system in accordance with an embodiment of the present invention may further include a holding mechanism configured to hold the inspection target at a position between the radiation source section and the sensor section. With this configuration, the radiation source section emits, to an inspection target held by the holding mechanism, an electromagnetic wave capable of passing through the inspection target, and the sensor section detects the electromagnetic wave. The above configuration thus makes it possible to inspect an inspection target for a defect therein.

An inspection system in accordance with an embodiment of the present invention may be arranged such that the inspection target is a separator roll including a core and a separator wound around the core, and the radiation source section is configured to emit the electromagnetic wave from a side of a side surface of the separator roll.

The above configuration makes it possible to closely inspect only the separator wound around the core.

A separator roll has not so small a thickness of, for example, several centimeters. The electromagnetic wave needs to have a high energy to pass through a separator roll. Including a second chamber separate from the first chamber can ensure safety of an operator more reliably.

An inspection system in accordance with an embodiment of the present invention may be arranged such that the first chamber and the second chamber are separated from each other by a space different from the first chamber and the second chamber.

A method in accordance with an embodiment of the present invention for driving an inspection system is a method for driving an inspection system, the inspection system including: a radiation source section configured to emit an electromagnetic wave capable of passing through an inspection target; a sensor section configured to detect the electromagnetic wave, which the radiation source section has emitted and which has passed through the inspection target; a stocking mechanism configured to stock the inspection target; a first chamber surrounded by a first wall that blocks the electromagnetic wave; a second chamber surrounded by a second wall that blocks the electromagnetic wave; and a first blocking section configured to allow the first chamber and the second chamber to communicate with each other, the first blocking section being capable of being opened and closed, the radiation source section and the sensor section being present in the first chamber, the stocking mechanism being present in the second chamber, the method comprising: placing the inspection target at a position between the radiation source section emitting the electromagnetic wave and the sensor section; the sensor section detecting the electromagnetic wave, which has passed through the inspection target, and outputting an electric signal corresponding to the electromagnetic wave that the sensor section has detected; after the sensor section has outputted the electric signal, carrying the inspection target, placed at the position between the radiation source section emitting the electromagnetic wave and the sensor section, into the second chamber; and placing another inspection target stocked in the second chamber at the position between the radiation source section emitting the electromagnetic wave and the sensor section.

The above process involves replacing an inspection target without turning the radiation source section on and off. This saves the time period necessary to turn the radiation source section 2 on and off, and also prevents degradation caused to the radiation source section by frequently turning the radiation source section on and off.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 1B to 1C, 1E to 1N, 1P to 1T, 1TA, 1TB Inspection system
2 Radiation source section
2a Emitting surface
2c Focus
3, 3A Sensor section
3Aa Detecting section
3Ab Inspection image
3b Target region
4, 4a Electromagnetic wave
5 Foreign object
6 Slitting apparatus
7 Stainless steel
8, c, u, 1 Core
8a First through hole
8b Second through hole
9, 9A Inspection device
10, 110, 111 Separator roll
10b First side surface
10c Second side surface
12 Separator
20, 20A Holding mechanism
30, 30B Control section
31 Radiation source control section
32D Holding mechanism control section
33 Sensor control section
34 Robot control section
234 Second arm section
35 Conveyor control section
41 First chamber
42, 46 to 49 Second chamber
43, 143 Third chamber
44 Fourth chamber
45 Fifth chamber
46 Sixth chamber
51, 51Q to 51S First blocking section
52, 52IN, 52OUT, 52a to 52d, 65 Second blocking section
201, 201N, 202, 202N Rack (stocking mechanism)
203, 2031 to 2033 Robot arm
206 to 208 Conveyor belt (stocking mechanism)
221, 221N Holding member
231 Base
232 Pedestal
233 First arm section
235 Hand part
351 Base part
352 First gripping section
352a, 352b, 353a, 353b Finger section
500 Operator
600 Packaging device

1. An inspection system, comprising:
a radiation source section configured to emit an electromagnetic wave capable of passing through an inspection target;
a sensor section configured to detect the electromagnetic wave, which the radiation source section has emitted and which has passed through the inspection target;
a stocking mechanism configured to stock the inspection target;
a first chamber surrounded by a first wall that blocks the electromagnetic wave;
a second chamber surrounded by a second wall that blocks the electromagnetic wave; and
a first blocking section configured to allow the first chamber and the second chamber to communicate with each other, the first blocking section being capable of being opened and closed,
the radiation source section and the sensor section being present in the first chamber,
the stocking mechanism being present in the second chamber.

2. The inspection system according to claim 1, wherein
the second wall is provided with, at a position other than a position of the first blocking section, a second blocking section capable of being opened and closed.

3. The inspection system according to claim 1, further comprising:
a conveying mechanism configured to (i) hold the inspection target stocked on the stocking mechanism and carry the inspection target from the second chamber to the first chamber through the first blocking section and (ii) carry the inspection target from the first chamber to the second chamber through the first blocking section.

4. The inspection system according to claim 2, wherein
the first blocking section is positioned so as not to be irradiated directly with the electromagnetic wave, which the radiation source section has emitted.

5. The inspection system according to claim 2, wherein
the first blocking section and the second blocking section are non-parallel to each other.

6. The inspection system according to claim 1, wherein
the stocking mechanism is a rack including a holding member configured to hold the inspection target.

7. The inspection system according to claim 1, wherein
the stocking mechanism is a conveyor either extending from outside the second chamber into the second chamber or extending through the second chamber.

8. The inspection system according to claim 1, wherein
the electromagnetic wave is an X ray.

9. The inspection system according to claim 1, further comprising:
a holding mechanism configured to hold the inspection target at a position between the radiation source section and the sensor section.

10. The inspection system according to claim 8, wherein
the inspection target is a separator roll including a core and a separator wound around the core, and
the radiation source section is configured to emit the electromagnetic wave from a side of a side surface of the separator roll.

11. The inspection system according to claim 1, wherein
the first chamber and the second chamber are separated from each other by a space different from the first chamber and the second chamber.

12. A method for driving an inspection system,
the inspection system including:
a radiation source section configured to emit an electromagnetic wave capable of passing through an inspection target;
a sensor section configured to detect the electromagnetic wave, which the radiation source section has emitted and which has passed through the inspection target;
a stocking mechanism configured to stock the inspection target;
a first chamber surrounded by a first wall that blocks the electromagnetic wave; a second chamber surrounded by a second wall that blocks the electromagnetic wave; and
a first blocking section configured to allow the first chamber and the second chamber to communicate with each other, the first blocking section being capable of being opened and closed,
the radiation source section and the sensor section being present in the first chamber,
the stocking mechanism being present in the second chamber,
the method comprising:
placing the inspection target at a position between the radiation source section emitting the electromagnetic wave and the sensor section;
the sensor section detecting the electromagnetic wave, which has passed through the inspection target, and outputting an electric signal corresponding to the electromagnetic wave that the sensor section has detected;
after the sensor section has outputted the electric signal, carrying the inspection target, placed at the position between the radiation source section emitting the electromagnetic wave and the sensor section, into the second chamber; and
placing another inspection target stocked in the second chamber at the position between the radiation source section emitting the electromagnetic wave and the sensor section.
